(19) United States
(12) Patent Application Publication
(10) Pub. No.: US 2026/0070385 A1
(43) Pub. Date: Mar. 12, 2026

(54) Base Valve With Open Bleed Tuning Capabilities

(71) Applicant: Advanced Suspension Technology LLC, Northville, MI (US)

(72) Inventor: Franky MONTAGNA, Bilzen (BE)

(21) Appl. No.: 18/826,694

(22) Filed: Sep. 6, 2024

(51) Int. Cl. B60G 13/08

(52) U.S. Cl. CPC B60G 13/08; B60G 2202/24; B60G 2202/312; B60G 2206/41; B60G 2800/162

(57) ABSTRACT

A shock absorber for a vehicle including a pressure tube, a reserve tube, a piston assembly, and a base valve assembly. The base valve assembly has a valve body including a rebound flow passage, a first circumferential land surrounding the rebound flow passage, a second circumferential land surrounding a bleed flow passage, and a third circumferential land surrounding a compression flow passage. The base valve assembly may further include a rebound valve assembly, a bleed valve assembly, and a compression valve assembly. The rebound valve assembly may be selectively driven into engagement with the first circumferential land, the bleed valve assembly includes a first portion that may be selectively driven into engagement with the second circumferential land and a second portion spaced apart from the valve body, and the compression valve assembly may be selectively driven into engagement with the third circumferential land.

### FIELD

The present disclosure relates to automotive shock absorbers/dampers. More particularly, the present disclosure relates to components of shock absorbers/dampers that provide optimized bleed range and tunability.

### BACKGROUND

The statements in this section merely provide background information related to the present disclosure and may not constitute prior art.

Shock absorbers are used in conjunction with automotive suspension systems to absorb unwanted vibrations which occur during driving. To absorb the unwanted vibrations, shock absorbers are generally connected between the sprung portion (body) and the unsprung portion (suspension) of the automobile. A piston is located within a pressure tube of the shock absorber and the pressure tube is connected to one of the sprung portion and the unsprung portion of the vehicle. The piston is connected to the other of the sprung portion and unsprung portion of the automobile through a piston rod which extends through the pressure tube. The piston divides the pressure tube into an upper working chamber and a lower working chamber both of which are filled with hydraulic fluid. Because the piston is able, through valving, to limit the flow of the hydraulic fluid between the upper and the lower working chambers when the shock absorber is compressed or extended, the shock absorber is able to produce a damping force which counteracts the vibration which would otherwise be transmitted from the unsprung portion to the sprung portion of the vehicle. In a dual-tube shock absorber, a fluid reservoir or reserve chamber is defined between the pressure tube and a reserve tube. A base valve is located between the lower working chamber and the reserve chamber to also produce a damping force which counteracts the vibrations which would otherwise be transmitted from the unsprung portion of the vehicle to the sprung portion of the automobile.

As described above, for a dual-tube shock absorber, the valving on the piston limits the flow of damping fluid between the upper and lower working chambers when the shock absorber is extended to produce a damping load. The valving on the base valve limits the flow of damping fluid between the lower working chamber and the reserve chamber when the shock absorber is compressed to produce a damping load. For a mono-tube shock absorber, the valving on the piston limits the flow of damping fluid between the upper and lower working chambers when the shock absorber is extended or compressed to produce a damping load. During driving, the suspension system moves in jounce (compression) and rebound (extension). During jounce movements, the shock absorber is compressed causing damping fluid to move through the base valve in a dual-tube shock absorber or through the piston valve in a mono-tube shock absorber. A damping valve located on the base valve or the piston controls the flow of damping fluid and thus the damping force created. During rebound movements, the shock absorber is extended causing damping fluid to move through the piston in both the dual-tube shock absorber and the mono-tube shock absorber. A damping valve located on the piston controls the flow of damping fluid and thus the damping force created.

In a dual-tube shock absorber, the piston and the base valve normally include a plurality of compression passages and a plurality of extension passages. During jounce movements in a dual-tube shock absorber, the damping valve or the base valve opens the compression passages in the base valve to control fluid flow and produce a damping load. A check valve on the piston opens the compression passages in the piston to replace damping fluid in the upper working chamber but this check valve may or may not contribute to the damping load. The damping valve on the piston closes the extension passages of the piston and a check valve on the base valve closes the extension passages of the base valve during a compression movement. During rebound movements in a dual-tube shock absorber, the damping valve on the piston opens the extension passages in the piston to control fluid flow and produce a damping load. A check valve on the base valve opens the extension passages in the base valve to replace damping fluid in the lower working chamber but this check valve may or may not contribute to the damping load.

While there are various features and elements to tune a shock absorber, a need exists for improved tunability and repeatability of shock absorbers.

### SUMMARY

This section provides a general summary of the disclosure, and is not a comprehensive disclosure of its full scope or all of its features.

In accordance with one aspect of the subject disclosure, a shock absorber for a vehicle is provided. The shock absorber includes a pressure tube, a reserve tube surrounding the pressure tube to define a fluid reservoir chamber between the pressure tube and the reserve tube, a piston assembly slidably fitted in the pressure tube and separating the pressure tube into a first working chamber and a second working chamber; and a base valve assembly, the base valve assembly configured to control the flow of fluid between the second working chamber and the fluid reservoir chamber. The base valve assembly comprises a valve body. The valve body comprises a first surface on a first side of the valve body, a second surface on a second side of the valve body, a rebound flow passage extending through the valve body, a first circumferential land on the first side of the valve body surrounding the rebound flow passage, wherein the first circumferential land being located a first distance away from the first surface and a greater distance away from the second surface, a bleed flow passage extending through the valve body, a second circumferential land on the first side of the valve body surrounding the bleed flow passage, wherein the second circumferential land being located a second distance away from the first surface, wherein the second distance is less than the first distance, wherein the second circumferential land is between the first surface and the first circumferential land, and a compression flow passage extending through the valve body.

In accordance with another aspect of the subject disclosure, a shock absorber for a vehicle is provided. The shock absorber includes a pressure tube, a reserve tube surrounding the pressure tube to define a fluid reservoir chamber between the pressure tube and the reserve tube, a piston body slidably fitted in the pressure tube and separating the pressure tube into a first working chamber and a second working chamber, and a base valve assembly, the base valve assembly configured to control the flow of fluid between the second working chamber and the fluid reservoir chamber. The base valve assembly comprises a valve body and a bleed valve assembly. The valve body comprises a first surface on a first side of the valve body, a second surface on a second side of the valve body, a bleed flow passage extending through the valve body, and a bleed flow guide cavity fluidly connected to the bleed flow passage, the bleed flow guide cavity extending into the valve body from the first surface of the valve body. The bleed valve assembly has a first disc, at least a portion of the first disc configured to selectively cover at least a portion of the bleed flow passage and the bleed flow guide cavity.

In accordance with another aspect of the subject disclosure, a shock absorber for a vehicle is provided. The shock absorber includes a pressure tube, a reserve tube surrounding the pressure tube to define a fluid reservoir chamber between the pressure tube and the reserve tube, a piston body slidably fitted in the pressure tube and separating the pressure tube into a first working chamber and a second working chamber, and a base valve assembly, the base valve assembly configured to control the flow of fluid between the second working chamber and the fluid reservoir chamber. The base valve assembly comprises a valve body and a bleed valve assembly. The valve body comprises a first surface on a first side of the valve body, a second surface on a second side of the valve body, a bleed flow passage extending through the valve body, and a compression flow passage extending through the valve body. The bleed valve assembly is on the first side of the valve body, the bleed valve assembly having an orifice disc. The orifice disc includes a ring having a center hole, a first finger extending radially outward from the ring, the first finger configured to cover the bleed flow passage, and the first finger having a first bleed orifice, wherein the first bleed orifice remains open regardless of position of the orifice disc, and a restriction lobe, the restriction lobe configured to cover the compression flow passage.

Further areas of applicability and advantages will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an exemplary vehicle equipped with a shock absorber in accordance with the teachings of the present disclosure;

FIG. 2 is a fragmentary side view of a shock absorber constructed in accordance with the teachings of the present disclosure;

FIG. 3 is a partial fragmentary side view of the shock absorber illustrated in FIG. 2;

FIG. 4 is an exploded perspective view depicting a base valve assembly having a valve body, a bleed valve assembly, a rebound valve assembly, a compression valve assembly, a compression blowoff valve assembly, and a valve pin in accordance with the teachings of the present disclosure;

FIG. 5A is a perspective view of the first side of an exemplary valve body in accordance with the teachings of the present disclosure;

FIG. 5B is a perspective view of the first side of an exemplary valve body in accordance with the teachings of the present disclosure;

FIG. 6A is a cross-sectional view of the shock absorber taken from line X-X in FIG. 4 when the shock absorber is under a compression stroke with open bleed flow;

FIG. 6B is a cross-sectional view of the shock absorber taken from line X-X in FIG. 4 when the shock absorber is under a compression stroke with closing bleed flow;

FIG. 6C is a cross-sectional view of the shock absorber taken from line X-X in FIG. 4 when the shock absorber is under a compression stroke with closed bleed flow;

FIG. 6D is a cross-sectional view of the shock absorber taken from line Y-Y in FIG. 4 when the shock absorber is under a compression stroke with main flow;

FIG. 6E is a cross-sectional view of the shock absorber taken from line X-X in FIG. 4 when the shock absorber is under a compression stroke with closed bleed flow;

FIGS. 7A-7D are illustrations of the force response curves of the shock absorber during the compression strokes and the flows illustrated in FIGS. 6A-6E;

FIG. 8A is a cross-sectional view of the shock absorber taken from line X-X in FIG. 4 when the shock absorber is under a rebound stroke with open bleed flow and closed rebound flow;

FIG. 8B is a cross-sectional view of the shock absorber taken from line X-X in FIG. 4 when the shock absorber is under a rebound stroke with lifting bleed flow and closed rebound flow;

FIG. 8C is a cross-sectional view of the shock absorber taken from line X-X in FIG. 4 when the shock absorber is under a rebound stroke with lifting bleed flow and open rebound flow;

FIG. 9A is a cross-sectional view of the shock absorber taken from line Y-Y in FIG. 4 when the shock absorber is under a rebound stroke with open bleed flow and closed rebound flow;

FIG. 9B is a cross-sectional view of the shock absorber taken from line Y-Y in FIG. 4 when the shock absorber is under a rebound stroke with lifting bleed flow and closed rebound flow;

FIG. 9C is a cross-sectional view of the shock absorber taken from line Y-Y in FIG. 4 when the shock absorber is under a rebound stroke with lifting bleed flow and open rebound flow;

FIG. 10A is a perspective view of exemplary orifice disc of the shock absorber in accordance with the teachings of the present disclosure;

FIG. 10B is a perspective view of another exemplary orifice disc of the shock absorber in accordance with the teachings of the present disclosure;

FIG. 10C is a perspective view of another exemplary orifice disc of the shock absorber in accordance with the teachings of the present disclosure;

FIG. 10D is a perspective view of the exemplary orifice disc of FIG. 10A on an exemplary valve body;

FIG. 10E is a perspective view of the exemplary orifice disc of FIG. 10B on an exemplary valve body;

FIG. 10F is a perspective view of the exemplary orifice disc of FIG. 10C on an exemplary valve body;

FIG. 11 is an illustration of the force response curve of the shock absorber moving toward the compressed position;

FIG. 12 is an exploded perspective view of an exemplary base valve assembly in accordance with the teachings of the present disclosure; and

FIG. 13 is a cross-sectional view of the shock absorber taken from line Y-Y in FIG. 12.

Corresponding reference numerals indicate corresponding parts throughout the several views of the drawings.

### DETAILED DESCRIPTION

The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

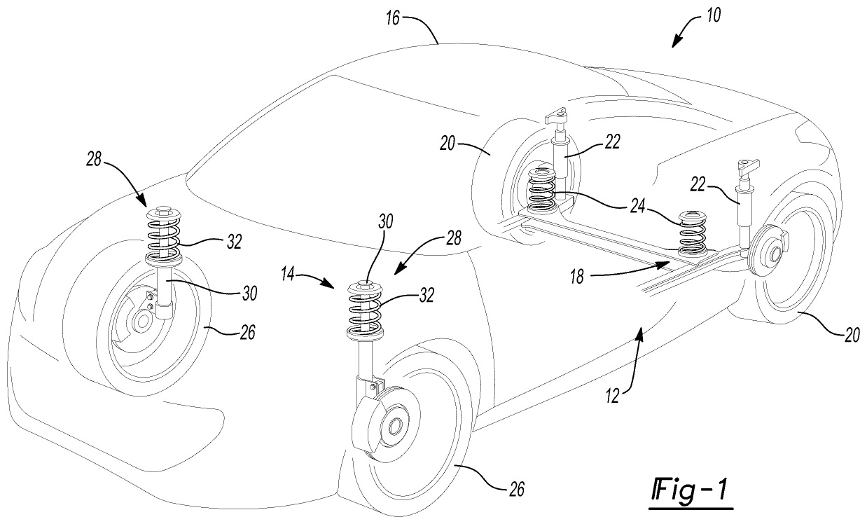

Referring to FIG. 1, an exemplary vehicle 10 including a rear suspension 12, a front suspension 14, and a body 16 is illustrated. Exemplary rear suspension 12 has a torsion beam assembly 18 configured to operatively support the vehicle's rear wheels 20. The torsion beam assembly 18 assembly is operatively connected to body 16, and includes a pair of shock absorbers 22 and a pair of helical coil springs 24. Similarly, the front suspension 14 includes a transversely extending front axle assembly (not shown) configured to operatively support the vehicle's front wheels 26. The front axle assembly is operatively connected to the body 16 by a pair of corner assemblies 28, which include a pair of shock absorbers 30 and by a pair of shaped helical coil springs 32. Shock absorbers 22 and 30 serve to dampen the relative motion of the unsprung portion (i.e., the front and rear suspensions 14 and 12, respectively) and the sprung portion (i.e., the body 16) of the vehicle 10. While the vehicle 10 has been depicted as a passenger car having front and rear axle assemblies, the shock absorbers 22 and 30 may be used with other types of vehicles and/or in other types of applications such as vehicles incorporating independent front and/or independent rear suspension systems. Further, the term “shock absorber” as used herein is meant to be dampers in general and thus will include struts. Also, while the front suspension 14 is illustrated having a pair of struts or shock absorbers 30, it is within the scope of the present invention to have the rear suspension 12 incorporate a pair of struts or shock absorbers 30 if desired.

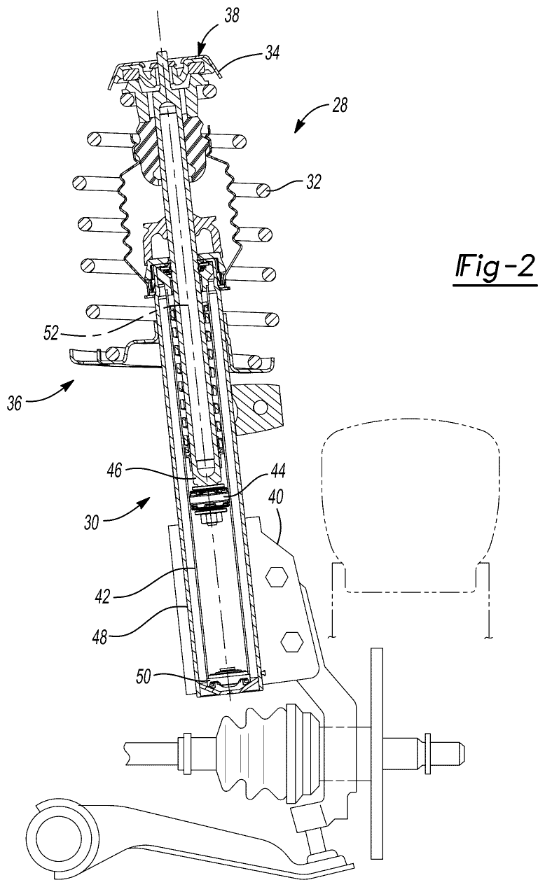

Referring now to FIG. 2, the front corner assembly 28 for the vehicle 10 is illustrated in greater detail. The body 16 of the vehicle 10 defines a shock tower 34 within which is mounted a strut assembly 36 that comprises a telescoping device in the form of the shock absorber 30, the coil spring 32, a top mount assembly 38, and a knuckle 40. The strut assembly 36 including the shock absorber 30, the coil spring 32, and the top mount assembly 38 are attached to the vehicle 10 using the shock tower 34. While the shock absorber 30 is illustrated in FIG. 2, it is to be understood that the shock absorber 22 may also include the features described herein for the shock absorber 30.

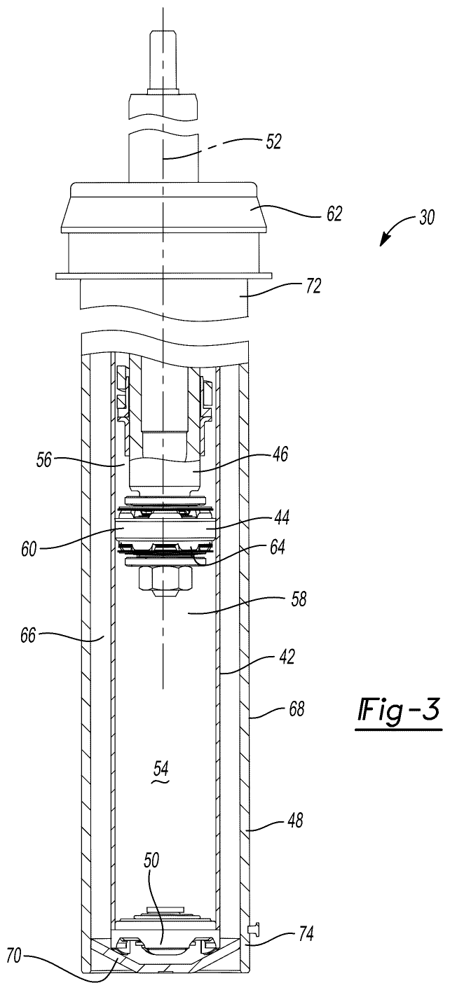

Referring now to FIGS. 2 and 3, additional details of the shock absorber 30 are shown. While FIG. 3 illustrates only the shock absorber 30, it is to be understood that the shock absorber 22 could also be a part of a strut assembly. The shock absorber 30 comprises a pressure tube 42, a piston assembly 44, a piston rod 46, a reserve tube assembly 48, and a base valve assembly 50. The pressure tube 42, piston rod 46, and reserve tube assembly 48 extend co-axially along a longitudinal axis 52.

The pressure tube 42 defines a fluid chamber 54. The piston assembly 44 is slidably disposed within the pressure tube 42 and divides the fluid chamber 54 into an upper working chamber 56 (or first working chamber) and a lower working chamber 58 (or a second working chamber). A piston band 60 is disposed between the piston assembly 44 and the pressure tube 42 to permit sliding movement of the piston assembly 44 with respect to the pressure tube 42 without generating undue frictional forces as well as sealing the upper working chamber 56 from the lower working chamber 58. The piston rod 46 is attached to the piston assembly 44 and extends through the upper working chamber 56 and through an oil seal cap 62 (also referred to as an upper end cap), which closes the upper end of pressure tube 42. A sealing system seals the interface between the oil seal cap 62, the reserve tube assembly 48, and the piston rod 46. The end of the piston rod 46 opposite to the piston assembly 44 is adapted to be secured to the top mount assembly 38 and to the sprung portion of the vehicle 10 as discussed above.

The piston assembly 44 includes a piston body 64 defining a plurality of flow passages (not shown), and valving that controls the movement of fluid through the plurality of flow passages and between the upper working chamber 56 and the lower working chamber 58 during movement of the piston assembly 44 within the pressure tube 42. Exemplary embodiments of the piston assembly 44 are shown and described in co-pending applications U.S. Ser. Nos. 18/313,460, 18/313,494, and 18/313,509, the entirety of which are incorporated by reference herein.

Because the piston rod 46 extends only through the upper working chamber 56 and not the lower working chamber 58, movement of the piston assembly 44 with respect to the pressure tube 42 causes a difference in the amount of fluid displaced in the upper working chamber 56 and the amount of fluid displaced in the lower working chamber 58. The difference in the amount of fluid displaced is known as the “rod volume”and it flows through the base valve assembly 50.

The reserve tube assembly 48 surrounds the pressure tube 42 to define a fluid reservoir chamber 66 located between the pressure tube 42 and the reserve tube assembly 48. The reserve tube assembly 48 includes a reserve tube 68 and a base cup 70. The reserve tube 68 has a top end 72 and a bottom end 74. The oil seal cap 62 is coupled to the top end 72 of the reserve tube 68. The base cup 70 is coupled to the bottom end 74 of the reserve tube 68 and closes the reserve tube 68 and the reserve tube assembly 48. While the base cup 70 is illustrated as a separate component, it is within the scope of the present disclosure to have the base cup 70 integral with reserve tube 68.

The base valve assembly 50 is disposed between the lower working chamber 58 and the fluid reservoir chamber 66 to control the flow of fluid between the lower working chamber 58 and the fluid reservoir chamber 66. When the shock absorber 30 extends in length, an additional volume of fluid is needed in the lower working chamber 58 due to the “rod volume” concept. Thus, fluid will flow from the fluid reservoir chamber 66 to the lower working chamber 58 through the base valve assembly 50 as detailed below. When the shock absorber 30 compresses in length, an excess of fluid must be removed from the lower working chamber 58 due to the “rod volume” concept. Thus, fluid will flow from the lower working chamber 58 to the fluid reservoir chamber 66 through the base valve assembly 50 as detailed below.

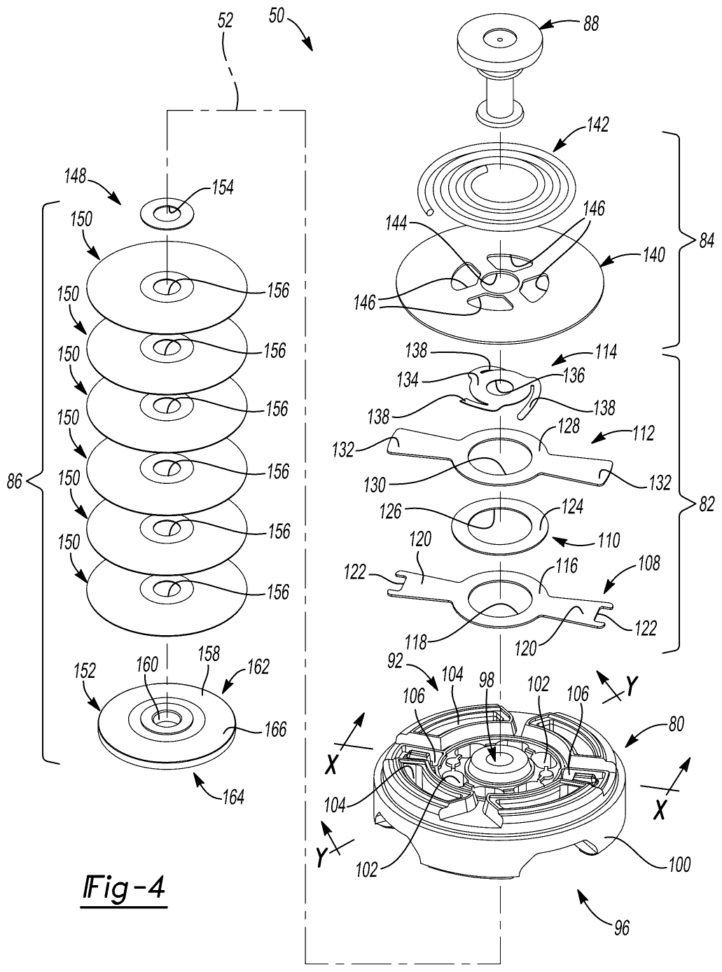

With additional reference to FIGS. 4, 6A-6E, and 8A-8C, the exemplary base valve assembly 50 comprises a valve body 80, a bleed valve assembly 82, a rebound valve assembly 84, and a compression valve assembly 86. The bleed valve assembly 82, the rebound valve assembly 84 and the compression valve assembly 86 are coupled to the valve body 80 using a valve pin 88 that is riveted in place; however, in other embodiments, the valve pin 88 may be welded in place. In other embodiments, the valve pin 88 may be threaded and may be secured with a bolt.

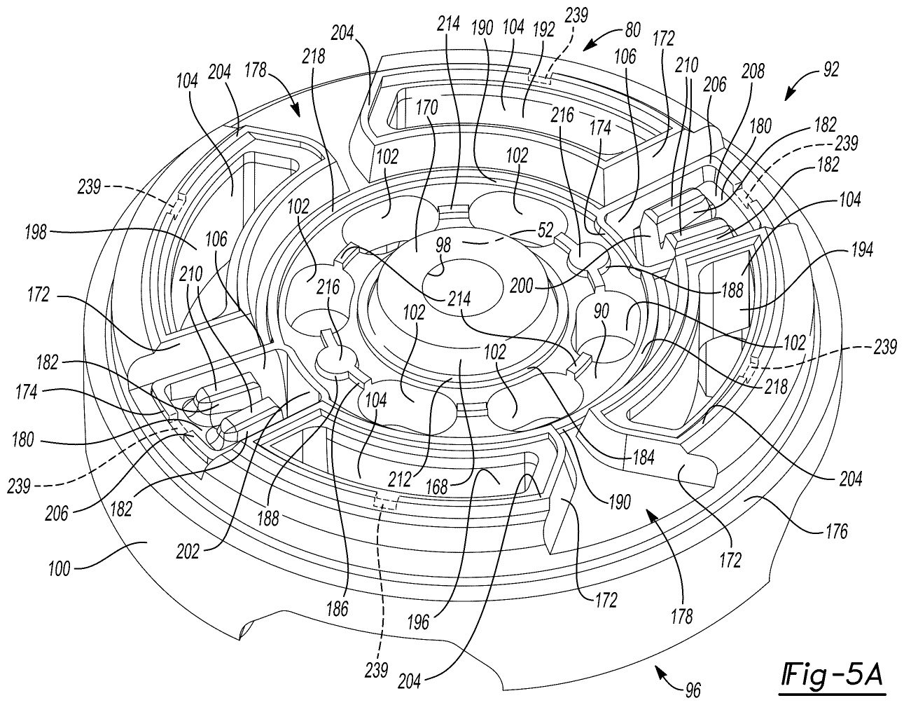

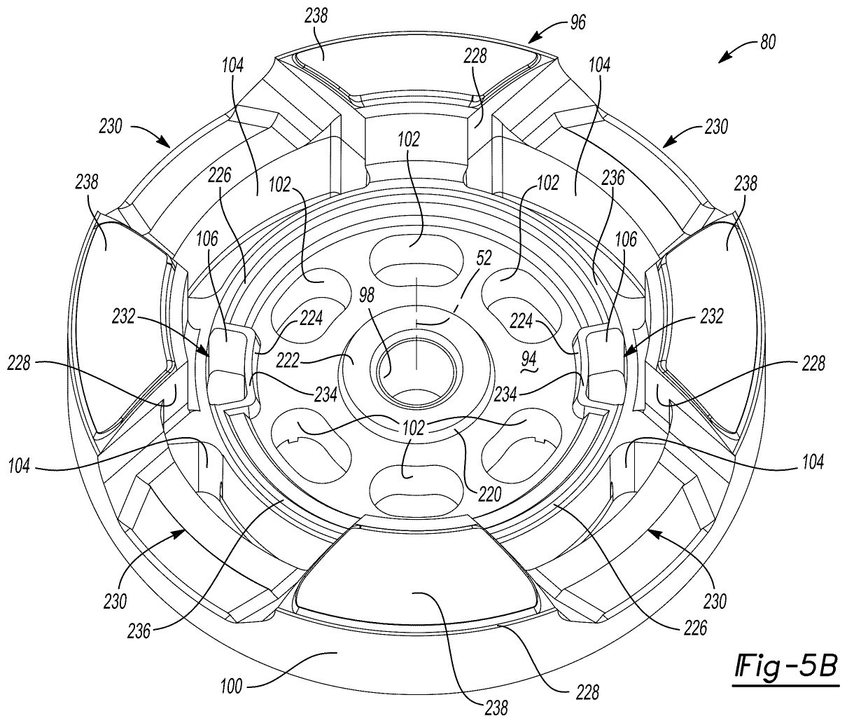

With reference to FIGS. 4, 5A, and 5B, the valve body 80 includes a first surface 90 on a first side 92 of the valve body 80 and a second surface 94 on a second side 96 of the valve body 80. The first surface 90 is opposite and spaced apart from the second surface 94 along the longitudinal axis 52. In some embodiments, the first surface 90 and the second surface 94 may be planar surfaces. The first surface 90 and the first side 92 may face the lower working chamber 58. The second surface 94 and the second side 96 may face the base cup 70 and the lower working chamber 58. The valve body 80 includes a center hole 98, through which the valve pin 88 is configured to extend. The valve body 80 further includes an outer circumferential surface 100. The valve body 80 defines a plurality of compression flow passages 102, a plurality of rebound flow passages 104, and a plurality of bleed flow passages 106. The compression flow passages 102, the rebound flow passages 104, and the bleed flow passages 106 are passages through which hydraulic fluid may flow. Thus, each of the compression flow passages 102, the rebound flow passages 104, and the bleed flow passages 106 may be referred to as a fluid passage.

### Bleed Valve Assembly

Referring again to FIG. 4, the bleed valve assembly 82 comprises, for example, a first set of valve components, such as an orifice disc 108, a fulcrum disc 110, a check disc 112, and a first spring 114. The orifice disc 108, the fulcrum disc 110, the check disc 112, and the first spring 114 of the bleed valve assembly 82 are configured to be in a stacked arrangement along the axis 52 on the first side 92 of the valve body 80.

With continued reference to FIGS. 4, 6A-6E, and 8A-8C, each of the orifice disc 108, the fulcrum disc 110, the check disc 112, and the first spring 114 are shown and described in greater detail.

### Orifice Disc

The orifice disc 108 includes a ring 116 having a center hole 118, and fingers 120 extending radially outward from the ring 116. In some embodiments, the fingers 120 are opposite each other such that the fingers 120 are spaced from each other at generally 180 degrees around the axis 52. The orifice disc 108 may be bow-tie shaped. For example, the width of the fingers 120 increases along the fingers 120, such that the fingers 120 get wider as the fingers 120 extend away from the ring 116. Although shown as bow-tie shaped, in some embodiments, the orifice disc 108 may have fingers 120 of other shapes, such as for example only, rectangular or square. Although shown as having two fingers 120, the orifice disc 108 may each include only one, or more than two, fingers 120.

The orifice disc 108 further includes one or more orifices 122. For example, each finger 120 includes one orifice 122 that extends radially inward from the outer edge of each finger 120 of the orifice disc 108.

The orifices 122 are configured to permit fluid flow axially and/or radially relative to the axis 52 of the shock absorber 30. The hydraulic fluid is able to flow through the orifices 122 and the bleed flow passages 106. Each orifice 122 is open in an axial direction and is configured to permit fluid flow axially relative to axis 52 (e.g., parallel to axis 52) through the orifice disc 108. Additionally, each orifice 122 is open in a radial direction and is configured to permit fluid flow radially relative to axis 52 (e.g., perpendicular to axis 52) through the orifices 122 at the outer edges of the fingers 120. In some embodiments, the orifices 122 are configured to remain open to fluid flow regardless of the position of the orifice disc 108.

### Fulcrum Disc

The fulcrum disc 110 comprises a ring 124 having a center hole 126. The fulcrum disc 110 is configured to provide a fulcrum point for the check disc 112.

### Check Disc

The check disc 112 includes a ring 128 having a center hole 130, and fingers 132 extending radially outward from the ring 128. In some embodiments, the fingers 132 are opposite each other such that the fingers 132 are spaced from each other at generally 180 degrees around the axis 52. The check disc 112 may be bow-tie shaped. For example, the width of the fingers 132 increases along the fingers 132, such that the fingers 132 get wider as the fingers 132 extend away from the ring 128. Although shown as bow-tie shaped, in some embodiments, the check disc 112 may have fingers 132 of other shapes, such as for example only, rectangular or square. Although shown as having two fingers 132, the check disc 112 may each include only one, or more than two, fingers 132. In some embodiments, the fingers 132 of the check disc 112 have the same size and shape as the fingers 120 of the orifice disc 108.

### Spring

The first spring 114 is shown as an arm spring including a ring 134 having a center hole 136, and a plurality of arms 138 extending circumferentially and radially outward from the ring 134. The plurality of arms 138 are further bent at an angle with respect to a plane formed by the ring 134. The first spring 114 is made from an elastically deformable material, such as for example, spring steel, plastic having suitable elastic properties, etc. Although shown as having three arms 138, the first spring 114 may each include only one, two, or more than three, arms 138. In some embodiments, the first spring 114 may be a wave spring, coil spring, or other type of biasing element without departing from the scope of the disclosure.

### Rebound Valve Assembly

The rebound valve assembly 84 comprises, for example, a second set of valve components, such as an intake or blowoff disc 140 and a second or intake spring 142. The intake or blowoff disc 140 and the second or intake spring 142 of the rebound valve assembly 84 are configured to be in a stacked arrangement along the axis 52 on the first side 92 of the valve body 80, wherein the bleed valve assembly 82 is configured to be located between the valve body 80 and the rebound valve assembly 84.

### Intake Disc

The intake disc 140 is a circular disc having a center hole 144 and a plurality of openings 146. The openings 146 are arranged about the axis 52. In some embodiments, the openings 146 of the intake disc 140 extend through the circular disc radially outward from the center hole 144. The intake disc 140 is shown having four openings 146. Such openings 146 may be spaced from each other circumferentially around the intake disc 140. The openings 146 are configured to decrease a stiffness of the intake disc 140. The openings 146 are configured to permit fluid flow from one side of the intake disc 140 to another side of the intake disc 140. Although shown as having four openings 146, in some embodiments, the intake disc 140 includes more than four openings 146. In some embodiments, the intake disc 140 includes less than four openings 146. In some embodiments, the intake disc 140 includes no openings 146. One or more of the shape, number, and size of the openings 146 may be modified or selected to tune the blowoff of the intake disc 140. Additionally or alternatively, the thickness of the intake disc 140 may be modified or selected to tune the blowoff of the intake disc 140.

### Second or Intake Spring

The second or intake spring 142 is a conical spring or a tapered spring. The second or intake spring 142 may be modified or selected to tune the blowoff of the intake disc 140. For example, one or more of the outer diameter, free length, wire diameter, number of coils, material type, and spring rate may be modified or selected to tune the blowoff of the intake disc 140. Although shown as a conical spring or tapered spring, in some embodiments, the second or intake spring 142 may be wave spring or other type of biasing element without departing from the scope of the disclosure.

### Compression Valve Assembly

The compression valve assembly 86 comprises, for example, a third set of valve components, such as a preload disc 148, one or more valve discs or plates 150, and a backup washer 152. The preload disc 148, the one or more valve discs or plates 150, and the backup washer 152 of the compression valve assembly 86 are configured to be in a stacked arrangement along the axis 52 on the second side 96 of the valve body 80.

With continued reference to FIGS. 4, 6A-6E, and 8A-8C, each of the preload disc 148, the one or more valve discs or plates 150, and the backup washer 152 are shown and described in greater detail.

### Preload Disc

The preload disc 148 is circular in shape, having a center hole 154. The preload disc 148 may be metal, plastic, or any suitable material. The preload disc 148 is configured to provide internal preload forces to the one or more valve discs 150. The thickness of the preload disc 148 may be modified or selected to tune the preload level of the one or more valve discs 150.

### Valve Discs

The valve discs 150 are circular discs and include a center hole 156. The valve discs 150 are elastically deformable. For example, force applied to an outer edge of the valve discs 150 may cause the valve discs 150 to flex such that the outer edge is moved axially relative the respective center hole 156 of the valve discs 150. The valve discs 150 are made from an elastically deformable material, such as for example, spring steel, plastic having suitable elastic properties, etc.

In some embodiments, each of the valve discs 150 have the same diameter. In some embodiments, the valve discs 150 have different diameters. For example, the valve discs 150 are arranged such that the valve disc 150 with the largest diameter is placed closest to the valve body 80 and the valve disc 150 with the smallest diameter is placed furthest away from the valve body 80. Accordingly, the diameter of each valve disc 150 decreases as a function of the distance from the valve body 80 along the axis 52. For example, the first valve disc 150 closest to the valve body 80 has a larger outer diameter than an outer diameter of an immediately adjacent valve disc 150, and so on. The valve disc 150 farthest from the valve body 80 thus has a diameter smaller than diameters of the other valve discs 150. As another example, the valve discs 150 may be configured similar to a leaf spring. One or more of the number of valve discs 150, the diameters of the valve discs 150, and the thicknesses of the valve discs 150 may be modified or selected to tune the blowoff of the valve discs 150.

### Backup Washer

The backup washer or valve stop 152 comprises a ring 158 having a center hole 160. The ring 158 of the backup washer 152 has a first side 162 and a second side 164 opposite the first side 162. In some embodiments, for example, as shown in FIGS. 4, 6A-6E, and 8A-8C, the ring 158 of the backup washer 152 includes an angled surface 166, wherein the angled surface 166 forms a frustoconical shape on the first side 162 of the backup washer 152. During operation of the shock absorber 30, the valve discs 150 may bend over the frustoconical shape of the backup washer 152. The backup washer 152 is configured to protect the valve discs 150. The backup washer 152 is configured to limit the deflection of the valve discs 150.

### Valve Body

### First Side of Valve Body

With reference to FIG. 5A, additional details of the valve body 80 are shown and described. As described above, the valve body 80 includes compression flow passages 102, rebound flow passages 104, and bleed flow passages 106, each of which pass through the valve body 80 and are open on the first side 92 of the valve body 80.

The valve body 80 further includes additional features that are provided on the first side 92 of the valve body 80. In some embodiments, the additional features of the valve body 80 include a first hub 168 surrounding the center hole 98 and extending from the first surface 90, the first hub 168 terminating in a first hub face 170, a plurality of first circumferential walls 172, and a plurality of second circumferential walls 174. The valve body 80 may further include one or more additional optional features, such as for example, a shoulder 176, one or more first side flow channels 178, one or more bleed flow guide cavities 180, one or more bleed inlet supports 182, one or more first ring supports 184, one or more second ring supports 186, one or more third ring supports 188, and one or more fourth ring supports 190. It will also be understood that in some embodiments of the valve body 80 not all features are required.

### Rebound Flow Passages

The plurality of rebound flow passages 104 includes, for example, a first rebound flow passage 192, a second rebound flow passage 194, a third rebound flow passage 196, and a fourth rebound flow passage 198. The plurality of rebound flow passages 104 are located proximate to the outer circumferential surface 100 of the valve body 80, radially outward from the center hole 98 and the plurality of compression flow passages 102. Although shown as having four rebound flow passages 104, in some embodiments, the valve body 80 includes more than four rebound flow passages 104. In some embodiments, the valve body 80 includes less than four rebound flow passages 104. For example, in some embodiments, the valve body 80 includes only two rebound flow passages 104. For example, in such embodiments, the first rebound flow passage 192 and the fourth rebound flow passage 198 may be formed as a single rebound flow passage 104, and the second rebound flow passage 194 and the third rebound flow passage 196 may be formed as another single rebound flow passage 104.

### Bleed Flow Passages

The plurality of bleed flow passages 106 includes, for example, a first bleed flow passage 200 and a second bleed flow passage 202. The plurality of bleed flow passages 106 are located radially outward from the center hole 98 and the plurality of compression flow passages 102. In some embodiments, the plurality of bleed flow passages 106 may be located a radial distance from the center hole 98 less than a radial distance of the rebound flow passages 104 from the center hole 98. That is, the plurality of bleed flow passages 106 may be located radially closer to the center hole 98 than the plurality of rebound flow passages 104. Although shown as having two bleed flow passages 106, in some embodiments, the valve body 80 includes more than two bleed flow passages 106. In some embodiments, the valve body 80 includes less than two bleed flow passages 106.

### Compression Flow Passages

The plurality of compression flow passages 102 includes, or example, six compression flow passages 102 that are circumferentially located around the first hub 168 of the valve body 80. Additionally, as shown in FIGS. 5A and 5B, the plurality of compression flow passages 102 are shown radially between the first hub 168 of the valve body 80 and the rebound flow passages 104. In some embodiments, the plurality of compression flow passages 102 may be located a radial distance from the center hole 98 less than a radial distance of the rebound flow passages 104 from the center hole 98 and a radial distance of the bleed flow passages 106. That is, the plurality of compression flow passages 102 may be located radially closer to the center hole 98 than the plurality of rebound flow passages 104 and the plurality of bleed flow passages 106. Although shown as having six compression flow passages 102, in some embodiments, the valve body 80 includes more than six compression flow passages 102. In some embodiments, the valve body 80 includes less than six compression flow passages 102.

### First & Second Circumferential Walls & Lands

The plurality of first circumferential walls 172 located on the first side 92 of the valve body 80 extend from the first surface 90 of the valve body 80 away from the second surface 94. Each first circumferential wall 172 terminates at a distal end with a first circumferential land 204. In some embodiments, the first circumferential lands 204 are parallel to the first surface 90. On the first side 92 of the valve body 80, each rebound flow passage 104 is surrounded by a respective first circumferential wall 172 and first circumferential land 204. In some embodiments, the first circumferential walls 172 and the first circumferential lands 204 form at least a portion of the respective rebound flow passages 104.

The first circumferential lands 204 on the first side 92 of the valve body 80 are located a first distance away from the first surface 90 and a greater distance from the second surface 94. During operation of the shock absorber 30, a blowoff disc, such as for example the intake disc 140, is configured to be selectively driven into engagement with the first circumferential lands 204. The first circumferential lands 204 provide a first sealing surface configured to selectively seal with a blowoff disc, such as for example the intake disc 140.

Although shown as having four first circumferential walls 172, in some embodiments, the valve body 80 includes more than four first circumferential walls 172. In some embodiments, the valve body 80 includes less than four first circumferential walls 172.

The plurality of second circumferential walls 174 located on the first side 92 of the valve body 80 extend from the first surface 90 of the valve body 80 away from the second surface 94. Each second circumferential wall 174 terminates at a distal end with a second circumferential land 206. In some embodiments, the second circumferential lands 206 are parallel to the first surface 90. On the first side 92 of the valve body 80, each bleed flow passage 106 is surrounded by a respective second circumferential wall 174 and second circumferential land 206. In some embodiments, the second circumferential walls 174 and the second circumferential lands 206 form at least a portion of the respective bleed flow passages 106.

The second circumferential lands 206 on the first side 92 of the valve body 80 are located a second distance away from the first surface 90 of the valve body 80. The second distance is less than the first distance. The second circumferential lands 206 are axially between the first surface 90 of the valve body 80 and the first circumferential lands 204.

During operation of the shock absorber 30, a portion of a bleed disc, such as for example the orifice disc 108, is configured to be selectively driven into engagement with the second circumferential lands 206. For example, at least portion of the fingers 120 of the orifice disc 108 are configured to be selectively driven into engagement with the second circumferential lands 206. When the fingers 120 are engaged with the second circumferential lands 206 the fingers 120 and the second circumferential lands 206 cooperate to form a seal at the interface between the fingers 120 and the second circumferential lands 206. The smaller surface area of the second circumferential lands 206 is easier to seal than the entire flat surface of a typical valve body. Additionally, the second circumferential walls 174 and the second circumferential lands 206 minimize the risk of small particles, such as contaminants, in the hydraulic fluid being stuck under the orifice disc 108, between the orifice disc 108 and the valve body 80, and creating a leak path. The second circumferential lands 206 therefore provide improved sealing capabilities of the orifice disc 108 and more repeatable closing behavior results as compared to typical valve bodies.

Although shown as having two second circumferential walls 174, in some embodiments, the valve body 80 includes more than two second circumferential walls 174. In some embodiments, the valve body 80 includes less than two second circumferential walls 174.

### Bleed Flow Guide Cavity

With continued reference to FIG. 5A, within the second circumferential wall 174 and proximate to the bleed flow passage 106, and between the second circumferential wall 174 and the bleed flow passage 106, there is provided the bleed flow guide cavity 180 extending into the valve body 80 from the first surface 90 of the valve body 80. The bleed flow guide cavity 180 is fluidly connected to the bleed flow passage 106. In some embodiments, the bleed flow guide cavity 180 includes an angled or sloped wall 208 that is angled or slopes toward the bleed flow passage 106, forming a flow guiding feature configured to enhance the flow of hydraulic fluid into the bleed flow passage 106. In some embodiments, some or all of the angled or sloped wall 208 is located between the first surface 90 and the second surface 94 of the valve body 80. The angled or sloped wall 208 may be angled with respect to the first surface 90 of the valve body 80. In some embodiments, the angle of the angled or sloped wall 208 with respect to the first surface 90 of the valve body 80 may range from about 10 degrees to about 90 degrees. In some embodiments, the angle of the angled or sloped wall 208 with respect to the first surface 90 of the valve body 80 may range from about 20 degrees to about 60 degrees. In some embodiments, the angle of the angled or sloped wall 208 with respect to the first surface 90 of the valve body 80 may range from about 30 degrees to about 50 degrees. In some embodiments, the angle of the angled or sloped wall 208 with respect to the first surface 90 of the valve body 80 may be about 45 degrees. In some embodiments, the angled or sloped wall 208 may be curved.

The bleed flow guide cavity 180 is configured to provide an increased available bleed tuning area. The bleed flow guide cavity 180 provides an additional area for hydraulic fluid flow. The bleed flow guide cavity 180 may be shaped to reduce the resistance to hydraulic fluid flow into and through the bleed flow passage 106.

As shown in FIGS. 5A, 6A, and 8A, in some embodiments, the valve body 80 further includes one or more bleed inlet supports 182. The one or more bleed inlet supports 182 are located within the one or more bleed flow guide cavities 180. The one or more bleed inlet supports 182 extend from the angled or sloped walls 208 away from the second surface 94 of the valve body 80. Each bleed inlet support 182 terminates at a distal end with a bleed land 210, wherein each bleed land 210 is coplanar with the second circumferential lands 206. Thus each bleed land 210 is located the same distance as the second distance of the second circumferential lands 206. As shown in FIG. 5A, for example, each bleed flow guide cavity 180 includes two bleed inlet supports 182. Although each bleed flow guide cavity 180 is shown as having two bleed inlet supports 182, in some embodiments, each bleed flow guide cavity 180 includes more than two bleed inlet supports 182. In some embodiments, each bleed flow guide cavity 180 includes less than two bleed inlet supports 182.

### First Ring Support and Land

The first ring support 184 is located on the first side 92 of the valve body 80. The first ring support 184 extends from the first surface 90 of the valve body 80 away from the second surface 94. The first ring support 184 terminates at a distal end with a first ring land 212, wherein the first ring land 212 is coplanar with the second circumferential lands 206. Thus the first ring land 212 is located the same distance as the second distance of the second circumferential lands 206. As shown in FIG. 5A, in some embodiments, the first ring support 184 extends along the first surface 90 circumferentially around the center hole 98 of the valve body 80 and is located at a radial distance from the axis 52 between the first hub 168 and the compression flow passages 102. Although shown as a continuous circular support around the first hub 168, it will be understood that in some embodiments, the first ring support 184 may be discontinuous, thus forming multiple first ring supports 184 and multiple first ring lands 212 around the first hub 168. The first ring supports 184 are located radially between the first hub 168 and the first circumferential lands 204 and the second circumferential lands 206.

### Second Ring Supports and Lands

The one or more second ring supports 186 of the valve body 80 are located on the first side 92 of the valve body 80. The second ring supports 186 extend from the first surface 90 of the valve body 80 away from the second surface 94. Each second ring support 186 terminates at a distal end with a second ring land 214, wherein each second ring land 214 is coplanar with the second circumferential lands 206 and the first ring land 212. Thus each second ring land 214 is located the same distance as the second distance of the second circumferential lands 206 and the first ring land 212. As shown in FIG. 5A, in some embodiments, the second ring lands 214 extend along the first surface 90, and partially circumferentially around the center hole 98 of the valve body 80 and are located at a radial distance from the axis 52 between the first ring land 212 and the rebound flow passages 104. For example, the second ring supports 186 are arcs of a circle and include one or more discontinuities or gaps between each second ring support 186, wherein those discontinuities or gaps are formed by the plurality of compression flow passages 102. In some embodiments, the discontinuities or gaps permit the flow of hydraulic fluid between the second ring supports 186, the first ring supports 184, and the plurality of compression flow passages 102. In some embodiments, the second ring supports 186 may extend radially between the first ring supports 184 and the rebound flow passages 104, wherein the one or more second ring supports 186 are disposed circumferentially spaced apart from one another around the center hole 98 of the valve body 80 between the compression flow passages 102. The second ring supports 186 are located radially between the first hub 168 and the first circumferential lands 204 and the second circumferential lands 206.

### Third Ring Supports and Lands

The one or more third ring supports 188 of the valve body 80 are located on the first side 92 of the valve body 80. The third ring supports 188 extend from the first surface 90 of the valve body 80 away from the second surface 94. Each third ring support 188 terminates at a distal end with a third ring land 216, wherein each third ring land 216 is coplanar with the second circumferential lands 206, the first ring land 212, and the second ring lands 214. Thus each third ring land 216 is located the same distance as the second distance of the second circumferential lands 206, the first ring land 212, and the second ring land 214. As shown in FIG. 5A, in some embodiments, the third ring supports 188 is located at a radial distance from the axis 52 between the first ring land 212 and the bleed flow passages 106. For example, the third ring supports 188 are circular in shape, with the third ring supports 188 and the third ring lands 216 forming pads. Although shown as circular in shape, it should be understood that the third ring supports 188 may have other shapes, such as for example, square, pentagonal, triangular, hexagonal, octagonal, without departing from the scope of the disclosure. The third ring supports 188 are located radially between the first hub 168 and the second circumferential lands 206.

### Fourth Ring Supports and Lands

The fourth ring supports 190 are located on the first side 92 of the valve body 80. The fourth ring supports 190 extend from the first surface 90 of the valve body 80 away from the second surface 94. Each fourth ring support 190 terminates at a distal end with a fourth ring land 218, wherein each fourth ring land 218 is coplanar with the second circumferential lands 206, the first ring land 212, the second ring lands 214, and the third ring lands 216. Thus the fourth ring lands 218 are located the same distance as the second distance of the second circumferential lands 206, the first ring land 212, the second ring lands 214, and the third ring lands 216. As shown in FIG. 5A, in some embodiments, the fourth ring supports 190 extend along the first surface 90 circumferentially around the center hole 98 of the valve body 80 and is located at a radial distance from the axis 52 between the first hub 168 and the rebound flow passages 104 and between the compression flow passages 102 and the rebound flow passages 104. In some embodiments, as shown in FIG. 5A, the fourth ring supports 190 connect with the second circumferential walls 174 and the fourth ring lands 218 connect with the second circumferential lands 206. In some embodiments, the fourth ring supports 190 do not connect with the second circumferential walls 174 and the fourth ring lands 218 do not connect with the second circumferential lands 206.

The ring lands 212, 214, 216, 218 are configured to support a surface of a bleed disc, such as the orifice disc 108. The lands 212, 214, 216, and 218 are further configured to prevent deformation of the orifice disc 108. The ring supports 184, 186, 188, 190 on the first side 92 allow for the hydraulic fluid to flow under the orifice disc 108, between the first surface 90 of the valve body 80 and the orifice disc 108. Therefore, the pressure delta that the orifice disc 108 will see is zero because the pressure below and above the orifice disc 108 will be equal. The second circumferential lands 206 and the ring lands 212, 214, 216, 218 are configured to support a portion of the surface of a bleed disc, such as the orifice disc 108, the second distance away from the first surface 90, wherein the bleed disc, the second circumferential walls 174, and the ring supports 184, 186, 188, 190 are configured to cooperate to form a fluid passage into which the hydraulic fluid may flow between the surface of the bleed disc and the first surface 90 of the valve body 80.

The ring supports 184, 186, 188, 190 serve to reduce the surface area contact between the orifice disc 108 and the valve body 80. With typical valve bodies having a substantially flat surface, there is a relatively large surface area contact between the valve body and any bleed disc placed in contact with the valve body. This relatively large surface area and the hydraulic fluid that can accumulate between the typical valve body and the bleed disc can result in sticking of the bleed disc to the valve body. This sticking can result in undesirable or uncontrolled opening and/or closing behavior of the bleed disc. Accordingly, the reduction in surface area contact provided by the ring supports 184, 186, 188, 190 reduces or eliminates sticking between the orifice disc 108 and the valve body 80, which can also reduce or eliminate undesirable or uncontrolled opening and/or closing behavior of the orifice disc 108. Additionally, the ring supports 184, 186, 188, 190 may reduce or eliminate contact noise between the orifice disc 108 and the valve body 80, which may reduce or eliminate noise, vibration, and harshness (NVH) issues. Additionally, together with the second circumferential walls 174 and the second circumferential lands 206, the ring supports 184, 186, 188, 190, and the ring lands 212, 214, 216, 218 aid in minimizing the risk of small particles, such as contaminants, in the hydraulic fluid being stuck under the orifice disc 108, between the orifice disc 108 and the valve body 80, and creating a leak path. The second circumferential lands 206 and ring lands 212, 214, 216, 218 may therefore provide improved sealing capabilities of the orifice disc 108 and more repeatable closing behavior results as compared to typical valve bodies.

### First Side Flow Channels

With continued reference to FIG. 5A, in some embodiments, the valve body 80 includes one or more optional first side flow channels 178 located circumferentially between two of the first circumferential walls 172. For example, a first of the first side flow channels 178 is located circumferentially between the second rebound flow passage 194 and the third rebound flow passage 196 and a second of the first side flow channels 178 is located circumferentially between the fourth rebound flow passage 198 and the first rebound flow passage 192. At least a portion of the first side flow channels 178 may have a curved shape and the first side flow channels 178 may have a width that varies from a first width proximate to the outer circumferential surface 100 of the valve body 80 to a second width proximate to the center hole 98 of the valve body 80, where the first width is greater than the second width. The first side flow channels 178 may be wider proximate to the outer circumferential surface 100 of the valve body 80 and narrower proximate to the center hole 98 of the valve body 80. The optional first side flow channels 178 may aid in guiding the flow of hydraulic fluid to the compression flow passages 102.

### Shoulder

With reference to FIG. 5A, the shoulder 176 is located proximate to the outer circumferential surface 100 of the valve body 80 and extends around the circumference of the valve body 80. The shoulder 176 is located radially outside of the first circumferential walls 172 and the rebound flow passages 104. In some embodiments, as shown in FIG. 5A, the shoulder 176 abuts the outer circumferential surface 100. As shown in FIG. 3, when the base valve assembly 50 is assembled into the shock absorber 30, the pressure tube 42 is seated and sealed against the shoulder 176.

### Second Side of Valve Body

With reference to FIG. 5B, additional details of valve body 80 are shown and described. As described above, the valve body 80 includes compression flow passages 102, rebound flow passages 104, and bleed flow passages 106, each of which pass through the valve body 80 and are open on the second side 96 of the valve body 80.

The valve body 80 further includes additional features that are provided on the second side 96 of the valve body 80. In some embodiments, the additional features of the valve body 80 include a second hub 220 surrounding the center hole 98 and extending from the second surface 94, the second hub 220 terminating in a second hub face 222, a plurality of first disc supports 224, a plurality of second disc supports 226, a plurality of legs 228, and one or more second side flow channels 230.

### First & Second Disc Supports & Lands

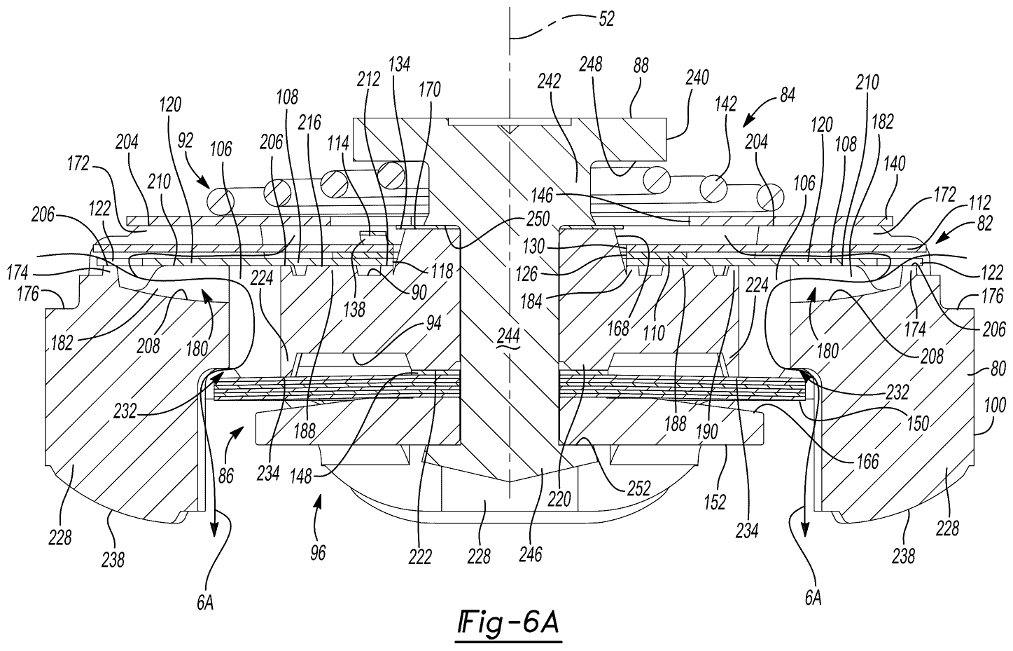

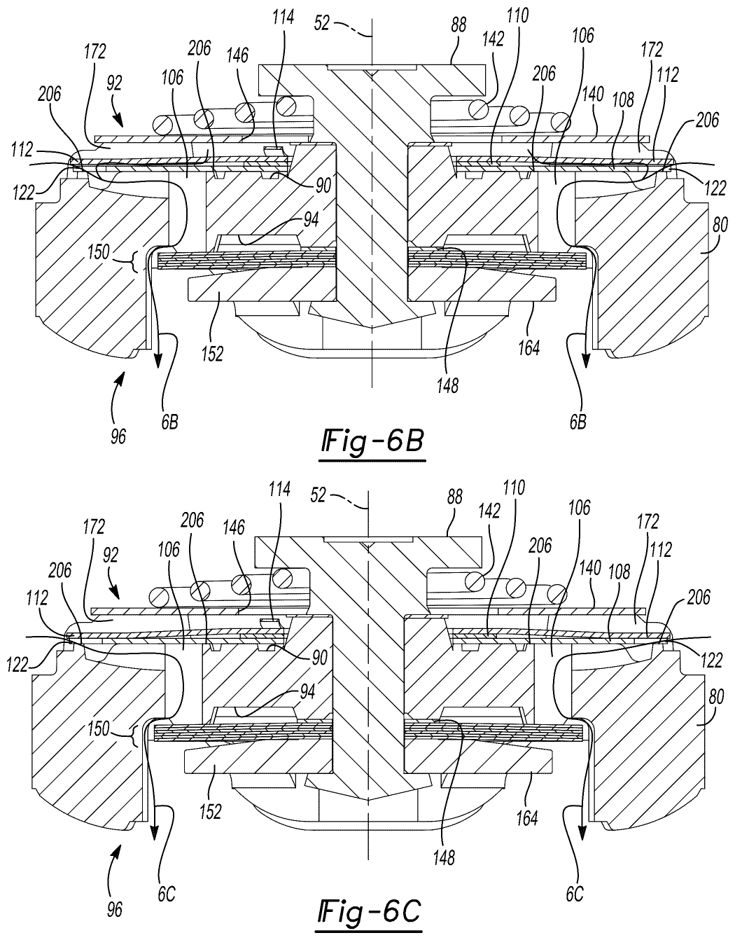

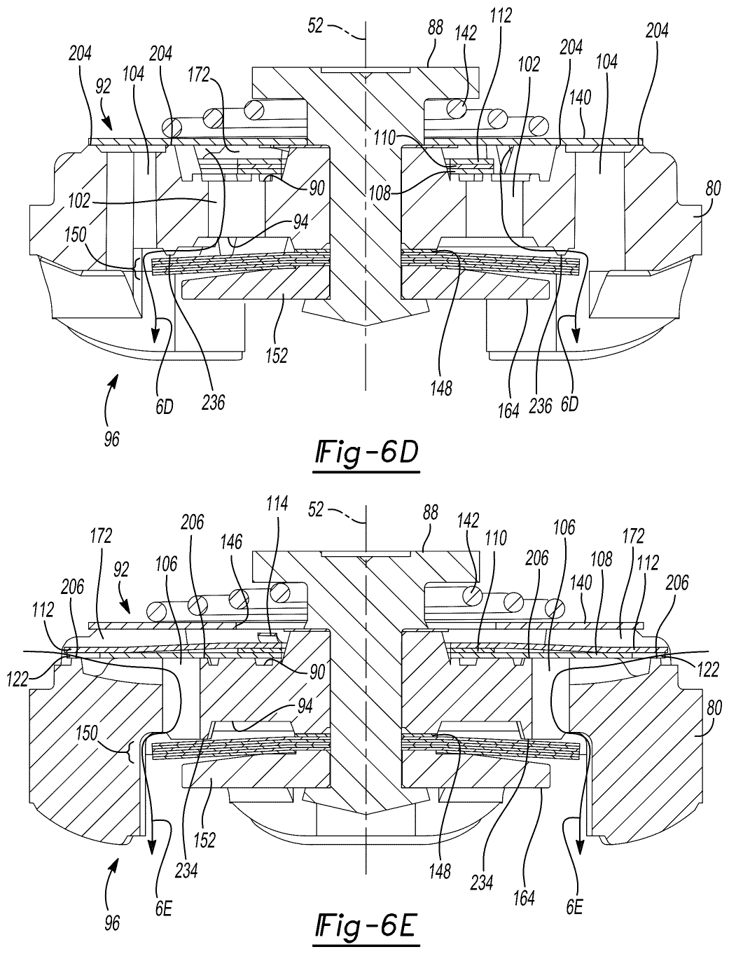

The plurality of first disc supports 224 located on the second side 96 of the valve body 80 extend from the second surface 94 of the valve body 80 away from the first surface 90. Each first disc support 224 terminates at a distal end with a first disc land 234. In some embodiments, the first disc supports 224 are parallel to the second surface 94. On the second side 96 of the valve body 80, each bleed flow passage 106 is partially surrounded by a respective first disc support 224 and first disc land 234. In some embodiments, the first disc supports 224 and first disc lands 234 form at least a portion of the respective bleed flow passages 106. As shown in FIG. 6A, in some embodiments, the first disc supports 224 do not fully surround the bleed flow passage 106 and are open radially outward, with each first disc support 224 forming a bleed port 232 through which hydraulic fluid may flow. The bleed port 232 is configured to be open to the flow of hydraulic fluid even when the first valve disc 150 of the stack of valve discs 150 is in contact with the first disc lands 234

The first disc lands 234 located on the second side 96 of the valve body 80 of the valve body 80 are located a first distance away from the second surface 94 and a greater distance from the first surface 90. During operation of the shock absorber 30, a valve disc, such as for example one of the valve discs 150, is configured to be selectively driven into engagement with the first disc lands 234. The first disc lands 234 provide a sealing surface configured to selectively seal with a blowoff disc, such as for example the intake disc 140.

Although shown as having two first disc supports 224, in some embodiments, the valve body 80 includes more than two first disc supports 224. In some embodiments, the valve body 80 includes less than two first disc supports 224.

The plurality of second disc supports 226 located on the second side 96 of the valve body 80 extend from the second surface 94 of the valve body 80 away from the first surface 90. Each second disc support 226 terminates at a distal end with a second disc land 236, wherein each second disc support 226 is coplanar with the first disc lands 234. In some embodiments, the second disc supports 226 are parallel to the second surface 94.

Thus the second disc lands 236 are located the same distance as the first distance of the first disc lands 234. In some embodiments, the second hub face 222 of the second hub 220 is located the same distance as the first distance of the first disc lands 234 and the second disc lands 236. In some embodiments, the second hub face 222 of the second hub 220 is located a distance from the second surface 94 less than the first distance of the first disc lands 234 and the second disc lands 236. As shown in FIG. 5B, in some embodiments, the second disc supports 226 extend along the first surface 90 circumferentially around the center hole 98 of the valve body 80 and are located at a radial distance from the axis 52 between the second hub 220 and the rebound flow passages 104 and between the compression flow passages 102 and the rebound flow passages 104. In some embodiments, as shown in FIG. 5B, the second disc supports 226 connect with the first disc supports 224 and the second disc lands 236 connect with the first disc lands 234. In some embodiments, the second disc supports 226 do not connect with the first disc supports 224 and the second disc lands 236 do not connect with the first disc lands 234.

During operation of the shock absorber 30, a portion of a valve disc, such as for example a valve disc 150, is configured to be selectively driven into engagement with the first disc lands 234 and the second disc lands 236. When the valve disc 150 is engaged with the first disc lands 234 and the second disc lands 236 the valve disc 150 cooperates with the first disc lands 234 and the second disc lands 236 to form a seal at the interface between the valve disc 150 and the first disc lands 234 and the second disc lands 236. This engagement of the valve disc 150 with the first disc lands 234 and the second disc lands 236, and the seal formed thereby, prevents the flow of hydraulic fluid through the compression flow passages 102. The first disc lands 234 and the second disc lands 236 may be collectively referred to as a third circumferential land or a compression valve disc land.

The smaller surface area of the first disc lands 234 and the second disc lands 236 is easier to seal than the entire flat surface of a typical valve body. Additionally, the first disc support 224, the second disc supports 226, the first disc lands 234, and the second disc lands 236 minimize the risk of small particles, such as contaminants, in the hydraulic fluid being stuck under the stack of valve discs 150, between the second surface 94 of the valve body 80 and the stack of valve discs 150, and creating a leak path. The first disc lands 234, and the second disc lands 236 therefore provide improved sealing capabilities of the stack of valve discs 150 and more repeatable closing behavior results as compared to typical valve bodies.

### Legs

With continued reference to FIG. 5B, in some embodiments, the valve body 80 further includes one or more legs 228 on the second side 96 of the valve body 80. The one or more legs 228 extend from the second surface 94 of the valve body away from the first surface 90. Each leg 228 terminates at a distal end with a leg terminal surface 238. The leg terminal surfaces 238 are located a second distance from the second surface 94 of the valve body 80 greater than the first distance of the first disc lands 234 and the second disc lands 236. The legs 228 are located proximate to the outer circumferential surface 100 of the valve body 80. In some embodiments, as shown in FIG. 5B, at least a portion of each leg 228 is at the outer circumferential surface 100. As shown in FIG. 5B, in some embodiments, the legs 228 are located at a radial distance greater than the radial distance of the bleed flow passages 106. Although shown as having four legs 228, in some embodiments, the valve body 80 includes more than four legs 228. In some embodiments, the valve body 80 includes less than four legs 228.

The legs 228 are configured to support the valve body 80 on the base cup 70 of the reserve tube assembly 48 (see FIG. 3). For example, the leg terminal surface 238 of each leg 228 is configured to contact an inner surface of the base cup 70.

### Second Side Flow Channels

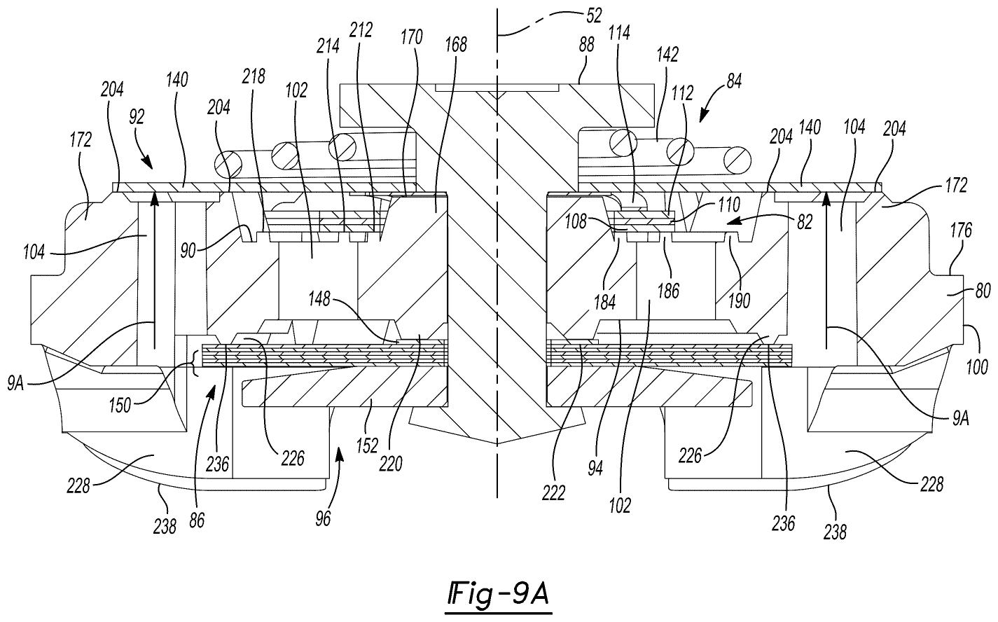

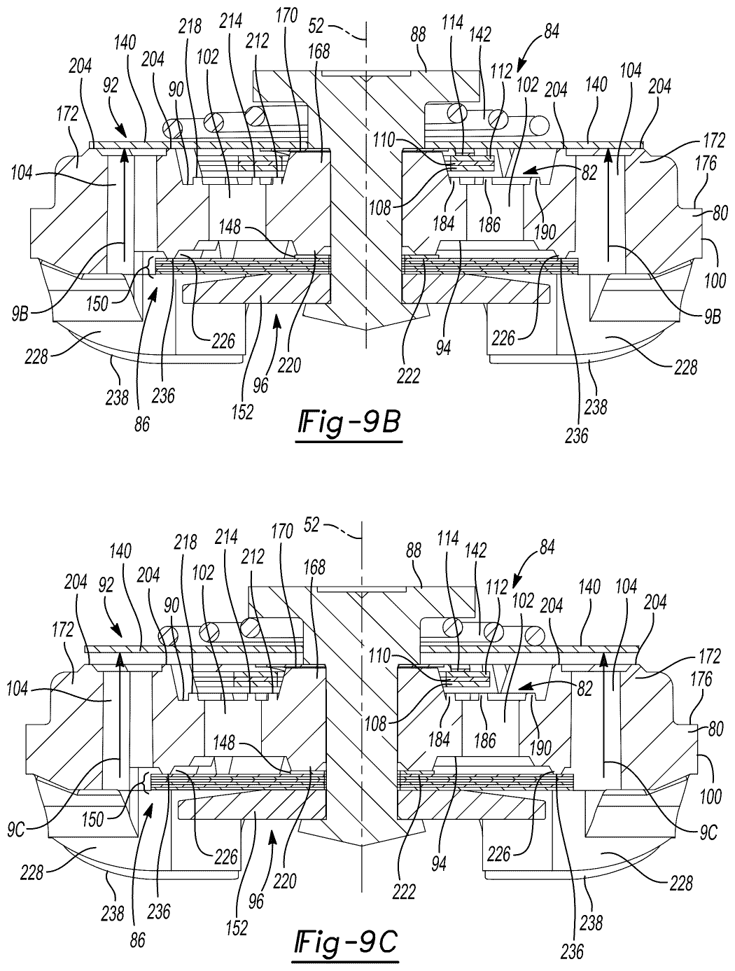

With continued reference to FIGS. 5B and 9A-9C, in some embodiments, the valve body 80 includes one or more second side flow channels 230 located circumferentially between the legs 228. For example, a second side flow channel 230 are located circumferentially between each leg 228. The second side flow channels 230 may aid in guiding the flow of hydraulic fluid to the rebound flow passages 104 between the base cup 70 and the valve body 80.

### Optional Notches

With reference again to FIG. 5A, the valve body 80 may optionally include one or more notches 239 in one or more of the first circumferential walls 172 and the second circumferential walls 174. In embodiments where the valve body 80 includes one or more notches 239 in one or more of the first circumferential walls 172, the notches 239 extend from one or more of the first circumferential lands 204 toward the first surface 90 of the valve body 80. In embodiments where the valve body 80 includes one or more notches 239 in one or more of the second circumferential walls 174, the notches 239 extend from one or more of the second circumferential lands 206 toward the first surface 90 of the valve body 80. The notches 239 are in fluid communication with respective rebound flow passages 104 or bleed flow passages 106. The notches 239 extend radially outward from the respective passage 104, 106. The notches 239 provide bleed flow of fluid into and/or out of the passages 104, 106. Notches 239 at the first circumferential walls 172 extending radially outward from the rebound flow passages 104 may provide fluid flow through the first circumferential walls 172 and below the intake disc 140 when the intake disc 140 covers the rebound flow passages 104. Additionally, in embodiments where the valve body 80 includes one or more notches 239 in one or more of the second circumferential walls 174, the orifice disc 108 may be omitted, and the notches 239 at the second circumferential walls 174 extending radially outward from the bleed flow passages 106 may provide fluid flow through the second circumferential walls 174 and below the check disc 112 when the check disc 112 covers the bleed flow passages 106. That is, the notches 239 in one or more of the second circumferential walls 174 may replace the orifice disc 108, e.g., the shock absorber 30 may not include the orifice disc 108. In some embodiments, the valve body 80 may optionally include one or more notches 239 in one or more of the second disc supports 226 that extend from one or more of the second disc lands 236 toward the second surface 94 of the valve body 80. Notches 239 in the second disc supports 226 extending radially outward from the compression flow passages 102 may provide fluid flow through the second disc supports 226 and below the valve disc 150 when the valve disc 150 covers the compression flow passages 102.

### Assembled Bleed Valve Assembly

Having described the components of the bleed valve assembly 82, the rebound valve assembly 84, and the compression valve assembly 86, the position and arrangement of the components of the bleed valve assembly 82 when assembled onto the valve body 80 and into the shock absorber 30 is described with reference to FIGS. 4, 6A-6E, 8A-8C, and 9A-9C. It will be understood that this arrangement of components is exemplary and in some embodiments the number, type, and arrangement of components may differ without departing from the scope of the invention.

When assembled into the shock absorber 30, the bleed valve assembly 82 is located on the first side 92 of the valve body 80. In particular, the orifice disc 108 is proximate to the first side 92 of the valve body 80, the first hub 168 is received in the center hole 118 of the orifice disc 108, and the fingers 120 selectively cover the bleed flow passages 106. For example, the fingers 120 are circumferentially aligned with, and extend radially beyond, the bleed flow passages 106. The orifice disc 108 is also in contact with the second circumferential lands 206 of the valve body 80 and the one or more bleed lands 210.

Additionally, when assembled into the shock absorber 30, the orifices 122 of the orifice disc 108 defines a radial open area (perpendicular to axis 52) and an axial open area (parallel to axis 52). The radial open area is defined by: (1) the width of the orifice 122 of the orifice disc 108; and (2) the thickness of the orifice disc 108. Therefore, radial open area may be modified by varying one or more of: (1) the width of the orifice 122 of the orifice disc 108; and (2) the thickness of the orifice disc 108. The radial open area provides a continuously open fluid flow path to allow for a radial open bleed flow. The axial open area is defined by the smaller of: (1) the width of the orifice 122 of the orifice disc 108; and (2) the length of the orifice 122 of the orifice disc 108. Therefore, the axial open area may be modified by varying at least one of: (1) the width of the orifice 122 of the orifice disc 108; or (2) the length of the orifice 122 of the orifice disc 108.

The fulcrum disc 110 is in contact with the orifice disc 108, wherein the orifice disc 108 is located between the valve body 80 and the fulcrum disc 110. Additionally, when assembled into the shock absorber 30, the first hub 168 is received in the center hole 126 of the fulcrum disc 110. The fulcrum disc 110 provides a fulcrum point or bending point for the check disc 112.

The check disc 112 is in contact with the fulcrum disc 110, wherein the orifice disc 108 and the fulcrum disc 110 are located between the valve body 80 and the check disc 112. Additionally, when assembled into the shock absorber 30, the first hub 168 is received in the center hole 130 of the check disc 112. Additionally, when assembled into the shock absorber 30, the fingers 132 of the check disc 112 are disposed above one or more of the fingers 120 of the orifice disc 108.

The check disc 112 is configured to selectively be in a first position and a second position. When the check disc 112 is in the first position, the fingers 132 of the check disc 112 are above the fingers 120 of the orifice disc 108 and may be separated a distance from the orifice disc 108 that is equal to the thickness of the fulcrum disc 110. Additionally, when the check disc 112 is in the first position, the axial open area and the radial open area are open to the flow of fluid. When the check disc 112 is in the second position, the fingers 132 of the check disc 112 contact the fingers 120 of the orifice disc 108 and cover the orifices 122 of the orifice disc 108. Additionally, when the check disc 112 is in the second position, the axial open area is closed to the flow of fluid and only the radial open area is open to the flow of fluid. The check disc 112 includes a first surface selectively engageable with an opposing surface of the orifice disc 108 to close the axial open area.

When assembled into the shock absorber 30, the ring 134 of the spring 114 is in contact with the first hub face 170 of the first hub 168. Additionally, the spring 114 is oriented such that the arms 138 of spring 114 abut the check disc 112 and serve to exert a force on the check disc 112. This force pushes the stacked check disc 112, fulcrum disc 110, and orifice disc 108 against the piston body.

### Assembled Rebound Valve Assembly

Having described the components of the rebound valve assembly 84, the position and arrangement of the components of the rebound valve assembly 84 when assembled into the shock absorber 30 are described with reference to FIGS. 4, 6A-6E, 8A-8C, and 9A-9C. It will be understood that this arrangement of components is exemplary and in some embodiments the number, type, and arrangement of components may differ without departing from the scope of the invention.

When assembled into the shock absorber 30, the rebound valve assembly 84 may be in contact with at least a part of the bleed valve assembly 82. For example, the intake disc 140 may be in contact with the spring 114 of the adjacent bleed valve assembly 82. The intake disc 140 is in contact with the first circumferential lands 204 of the valve body 80. The intake spring 142 is in contact with the intake disc 140 wherein the intake disc 140 is located between the valve body 80 and the intake spring 142. When assembled into the shock absorber 30, the bleed valve assembly 82 is located between the rebound valve assembly 84 and the first side 92 of the valve body 80 along the longitudinal axis 52.

### Assembled Compression Valve Assembly

Having described the components of the compression valve assembly 86, the position and arrangement of the components of the compression valve assembly 86 when assembled into the shock absorber 30 is described with reference to FIGS. 4, 6A-6E, 8A-8C, and 9A-9C. It will be understood that this arrangement of components is exemplary and in some embodiments the number, type, and arrangement of components may differ without departing from the scope of the invention.

When assembled into the shock absorber 30, the compression valve assembly 86 is located on the second side 96 of the valve body 80. In particular, the preload disc 148 is proximate to the second side 96 of the valve body 80, with the preload disc 148 in contact with the second hub face 222 of the second hub 220.

The plurality of valve discs 150 are provided, wherein a first valve disc 150 of the plurality of valve discs 150 is in contact with the preload disc 148, and wherein the preload disc 148 is located between the valve body 80 and the plurality of valve discs 150. The first valve disc 150 of the plurality of valve discs 150 is also in contact with the first disc lands 234 and the second disc lands 236.

The backup washer 152 is in contact with the last valve disc 150 of the plurality of valve discs 150. The first side 162 of the backup washer 152 faces the plurality of valve discs 150. In embodiments of the backup washer 152 that include the angled surface 166, the angled surface 166 faces the plurality of valve discs 150. The plurality of valve discs 150 are located between the valve body 80 and the backup washer 152.

### Valve Pin

The valve pin 88 couples together the bleed valve assembly 82, the rebound valve assembly 84, the compression valve assembly 86, and the valve body 80. With reference to FIG. 6A, the valve pin 88 includes a first head 240, a first shank portion 242, a second shank portion 244, and a second head 246. The first head 240 is at a proximal end of the valve pin 88 and the second head 246 is at a distal end of the valve pin 88 opposite the proximal end. The first shank portion 242 is proximate to the first head 240 and the second shank portion 244 is proximate to the second head 246. The first head 240 has a first diameter, the first shank portion 242 has a second diameter, the second shank portion 244 has a third diameter, and the second head 246 has a fourth diameter. The first diameter is larger than the second diameter, the second diameter is larger than the third diameter, and the fourth diameter is larger than the third diameter.

The valve pin 88 further includes a first shoulder 248 on the first head 240 proximate to the connection between the first head 240 and the first shank portion 242, a second shoulder 250 on the first shank portion 242 proximate to the connection between the first shank portion 242 and the second shank portion 244, and a third shoulder 252 on the second head 246 proximate to the connection between the second head 246 and the second shank portion 244.

When the base valve assembly 50 is assembled, as shown in FIG. 6A, the rebound valve assembly 84 is located between the first head 240 of the valve pin 88 and the valve body 80, and the compression valve assembly 86 is located between the second head 246 of the valve pin 88 and the valve body 80. The first shoulder 248 contacts and retains the intake spring 142 on the base valve assembly 50. The second shoulder 250 contacts the ring 134 of the first spring 114 and retains the first spring 114 against the first hub face 170 of the first hub 168 on the first side 92 of the valve body 80. The third shoulder 252 contacts the second side 164 of the backup washer 152 and retains the backup washer 152 on the base valve assembly 50.

### Function of Base Valve Assembly

### Compression Stroke—Open Bleed Flow

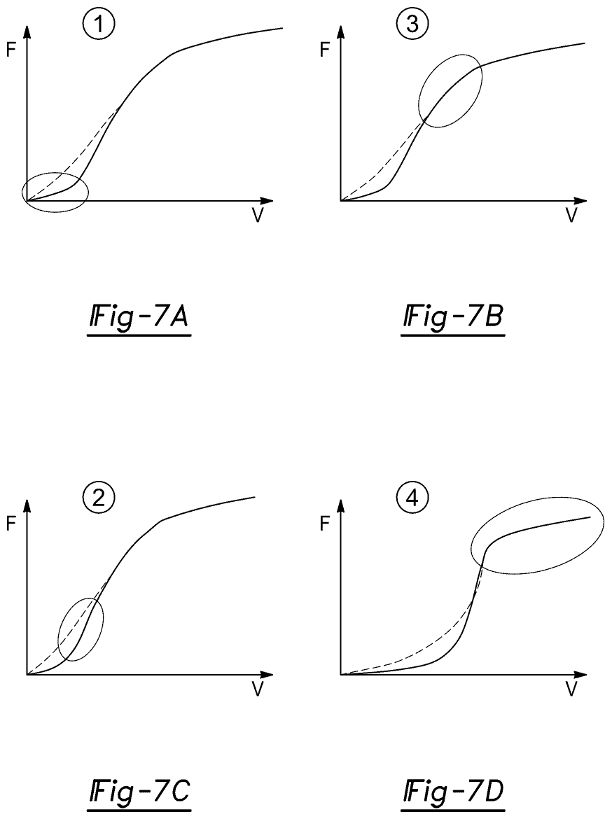

Referring now to FIGS. 6A-6E and 7A-7D, during a compression stroke of the piston assembly 44, there are four compression flows of fluid between the lower working chamber 58 and the fluid reservoir chamber 66. FIG. 6A illustrates the first compression flow of fluid, also known as the open bleed flow. The first compression flow of fluid is through a continuously open fluid flow path from the first side 92 of the valve body 80 through: (i) the radial open area formed by the orifices 122 extending to the edge of the orifice disc 108 of the bleed valve assembly 82, and (ii) the axial open area formed by the orifices 122 in the orifice disc 108 of the bleed valve assembly 82, which allows fluid flow at zero or near zero velocity of the piston assembly 44 during a compression stroke of the piston assembly 44. After passing through the orifices 122 of the orifice disc 108, the first flow of fluid continues through the bleed flow passage 106, and through the bleed port 232 on the second side 96 of the valve body 80. During the first flow of fluid, hydraulic fluid is able to flow through the orifices 122 of the orifice disc 108 from around the check disc 112. This first flow of fluid (open bleed flow) is shown by arrows labeled 6A.

Thus, in operation, a compression stroke of piston assembly 44 causes the fluid pressure in the lower working chamber 58 to increase. Initially, fluid flows into the bleed flow passages 106, through the orifices 122 in orifice disc 108, through the bleed flow passages 106, and through the bleed ports 232, and into the fluid reservoir chamber 66. This open bleed flow is shown in region 1 of the force response curve shown in FIG. 7A. FIGS. 7A-7B are graphs of force versus velocity (the force response curve) of shock absorbers moving toward the compressed position. The vertical or y-axis of the plot represents the force provided by the shock absorber 30 and the horizontal or x-axis of the plot represents the velocity of the piston rod 46.

### Compression Stroke—Closing Bleed Flow

FIG. 6B illustrates a second compression flow of fluid, also known as a closing bleed flow.

When the speed of the piston assembly 44 increases, fluid pressure within the lower working chamber 58 will increase and the fluid pressure force applied to the check disc 112 of the bleed valve assembly 82 will deflect the check disc 112 toward the orifice disc 108 (toward the first side 92 of the valve body 80) to start closing or shutting the axial open area formed by the orifices 122 in the orifice disc 108 of the bleed valve assembly 82 to start closing or shutting off the fluid flow through the axial open area of the orifices 122 in the orifice disc 108.

Thus, at a certain pressure differential between the lower working chamber 58 and the fluid reservoir chamber 66, the check disc 112 will be dragged or bent toward the first side 92 of the valve body 80, reducing the area open to the flow of hydraulic fluid and thus restricting the flow of hydraulic fluid. In the second flow of fluid condition, after passing through the orifices 122 of the orifice disc 108, the second flow of fluid continues through the bleed flow passage 106, and through the bleed port 232 on the second side 96 of the valve body 80. During the second flow of fluid, hydraulic fluid is still able to flow through the orifices 122 of the orifice disc 108 from around the check disc 112, albeit this second flow of fluid is restricted as compared to the first flow of fluid. This second flow of fluid (closing bleed flow) is shown by arrows labeled 6B. This closing bleed flow is shown in region 2 of the force response curve shown in FIG. 7B.

### Compression Stroke—Closed Bleed Flow

FIG. 6C illustrates a third flow of fluid, also known as a closed bleed flow. When the speed of the piston assembly 44 increases, fluid pressure within the lower working chamber 58 will increase and the fluid pressure force applied to the check disc 112 of the bleed valve assembly 82 will further deflect the check disc 112 toward the orifice disc 108 (toward the first side 92 of the valve body 80) to shut or close the axial open area (or second fluid flow) formed by the orifices 122 in the orifice disc 108 of the rebound bleed valve assembly 84 and only allow fluid flow through the radial open area formed by the orifices 122 in the orifice disc 108 of the rebound valve assembly 84.

Thus, at a certain pressure differential between the lower working chamber 58 and the fluid reservoir chamber 66, at least a portion of the check disc 112 will be in contact with the orifice disc 108, reducing the area open to the flow of hydraulic fluid to just the radial open area of the orifices 122 in the orifice disc 108 and thus further restricting the flow of hydraulic fluid. In the third flow of fluid condition, after passing through the radial open area portion of the orifices 122 of the orifice disc 108, the third flow of fluid continues through the bleed flow passage 106, and through the bleed port 232 on the second side 96 of the valve body 80. During the third flow of fluid, hydraulic fluid is only able to flow through the radial open area of the orifices 122 of the orifice disc 108 from around the check disc 112. This third flow of fluid is restricted as compared to the first flow of fluid and the second flow of fluid. This third flow of fluid (closing bleed flow) is shown by arrows labeled 6C. This closed bleed flow is shown in region 3 of the force response curve shown in FIG. 7C.

### Compression Stroke—Main Flow & Closed Bleed

FIGS. 6D and 6E illustrate a fourth flow of fluid, also known as a main flow. When the speed of the piston assembly 44 increases further and the bleed valve assembly 82 is in the closed bleed flow position, fluid pressure within the plurality of compression flow passages 102 will increase and the fluid pressure force applied to the stack of valve discs 150 of the compression valve assembly 86 will overcome the biasing load of the valve discs 150 and the valve discs 150 will move axially to open the plurality of compression flow passages 102 to provide the fourth flow of fluid.

Thus, at a certain pressure differential between the lower working chamber 58 and the fluid reservoir chamber 66, the valve discs 150 will become unseated from the first disc lands 234 and the second disc lands 236. This creates, or is considered, a blowoff condition. In the fourth flow of fluid condition, the fourth flow of fluid passed through the compression flow passage 102. This fourth flow of fluid is less restricted than the first flow of fluid, the second flow of fluid, and the third flow of fluid. This fourth flow of fluid (main flow) is shown by arrows labeled 6D and 6E. This closed bleed flow is shown in region 4 of the force response curve shown in FIG. 7D.

### Rebound Stroke—Closed Rebound Flow

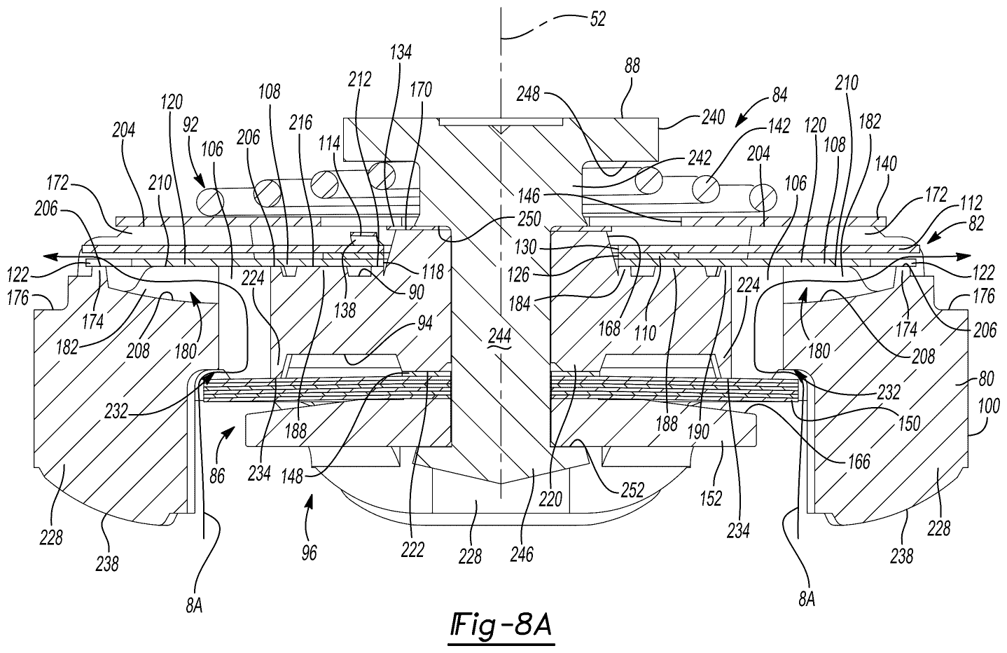

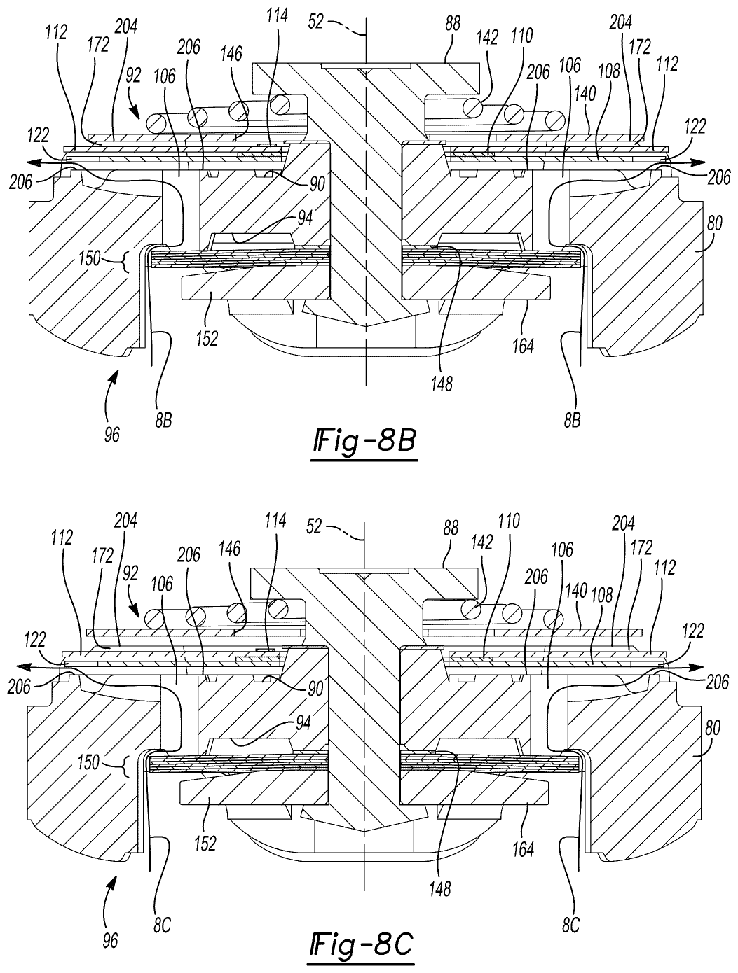

Referring now to FIGS. 8A-8C and 9A-9C, during a rebound stroke, there are three rebound flows of fluid between the lower working chamber 58 and the fluid reservoir chamber 66. During the rebound stroke, none of the three rebound flows of fluid are through the compression flow passages 102. As shown in each of FIGS. 8A-08C and 9A-9C, the compression valve assembly 86 is closed to prevent the flow of fluid through the compression flow passages 102. That is, a first valve disc 150 of the stack of valve discs 150 are sealingly engaged with the lands 234 and 236 to prevent the flow of fluid from the fluid reservoir chamber 66 to the lower working chamber 58 through the compression flow passages 102.

FIG. 8A illustrates the first rebound flow of fluid, also known as the closed rebound flow. The first rebound flow of fluid is through a continuously open fluid flow path from the second side 96 of the valve body 80 into the bleed port 232 on the second side 96 of the valve body 80, through the bleed flow passage 106, and through: (i) the radial open area formed by the orifices 122 extending to the edge of the orifice disc 108 of the bleed valve assembly 82, and (ii) the axial open area formed by the orifices 122 in the orifice disc 108 of the bleed valve assembly 82. The first rebound flow of fluid allows fluid flow at zero or near zero velocity of piston assembly 44 during a rebound stroke of the piston assembly 44.

Thus, in operation, a rebound stroke of the piston assembly 44 causes the fluid pressure in the lower working chamber 58 to decrease. Fluid flows from the fluid reservoir chamber 66 into the bleed ports 232, through the bleed flow passages 106, through the orifices 122 in orifice disc 108 of the bleed valve assembly 82 and into the lower working chamber 58. This first rebound flow of fluid (closed rebound flow) is shown by arrows labeled 8A of FIG. 8A. As shown in FIG. 9A, during this first rebound flow of fluid, the rebound valve assembly 84 is closed, wherein the intake disc 140 is in sealing engagement with the first circumferential lands 204.

### Rebound Stroke—Lifting Bleed Flow

FIG. 8B illustrates a second rebound flow of fluid, also known as a lifting bleed flow. When the speed of the piston assembly 44 increases, fluid pressure within the lower working chamber 58 will further decrease and the fluid pressure force applied to the orifice disc 108 will overcome the biasing load of the arm spring 114, and the orifice disc 108, the fulcrum disc 110, and the check disc of the bleed valve assembly 82 will move axially away from the first side 92 of the valve body 80. When this occurs, the orifice disc 108 will no longer be in sealing engagement with the second circumferential lands 206 around the bleed flow passages 106, opening the bleed flow passages 106 to provide the second rebound flow of fluid.

Thus, in operation, a rebound stroke of the piston assembly 44 causes the fluid pressure in the lower working chamber 58 to further decrease. Fluid flows from the fluid reservoir chamber 66 into the bleed ports 232, through the bleed flow passages 106, and into the lower working chamber 58. This second rebound flow of fluid (lifting bleed flow) is shown by arrows labeled 8B of FIG. 8B. As shown in FIG. 9B, during this second rebound flow of fluid, the rebound valve assembly 84 is closed, wherein the intake disc 140 is in sealing engagement with the first circumferential lands 204.

### Rebound Stroke—Lifting Intake

FIG. 8C illustrates a third rebound flow of fluid, also known as a lifting intake. When the speed of the piston assembly 44 increases further, fluid pressure within the lower working chamber 58 will further decrease and the fluid pressure force applied to the intake disc 140 of the rebound valve assembly 84 will overcome the biasing load of the intake spring 142 and the intake disc 140 will move axially away from the first side 92 of the valve body 80 to open the plurality of rebound flow passages 104 to provide the third flow of fluid.

Thus, in operation, a rebound stroke of the piston assembly 44 causes the fluid pressure in the lower working chamber 58 to further decrease. Fluid flows from the fluid reservoir chamber 66 into and through the rebound flow passages 104, and into the lower working chamber 58. This third rebound flow of fluid (lifting intake) is shown by arrows labeled 8C of FIG. 8C. As shown in FIG. 9C, during this third rebound flow of fluid, both the bleed valve assembly 82 and the rebound valve assembly 84 are open, wherein the intake disc 140 is not in sealing engagement with the first circumferential lands 204 and the orifice disc 108 not in sealing engagement with the second circumferential lands 206 around the bleed flow passages 106.

### Alternative Embodiment of Orifice Disc

### Restriction Lobes

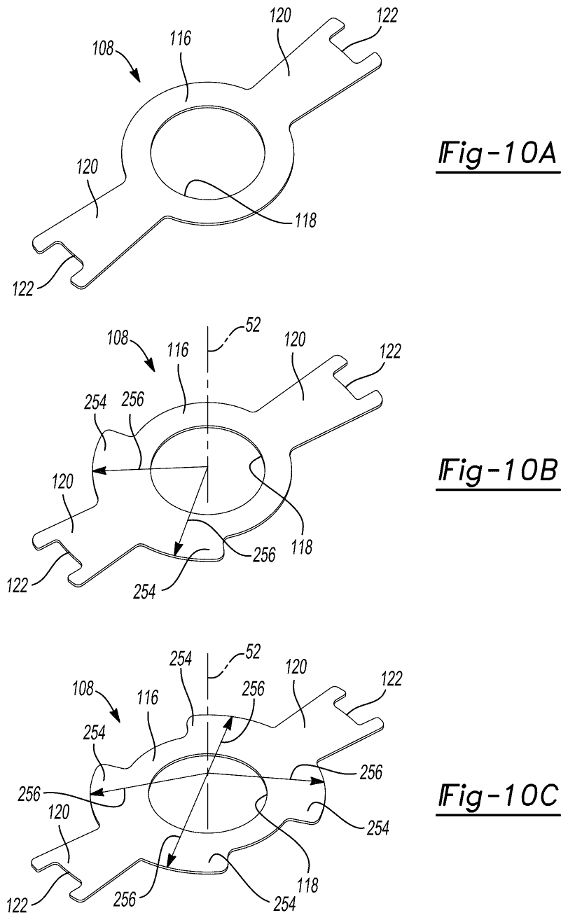

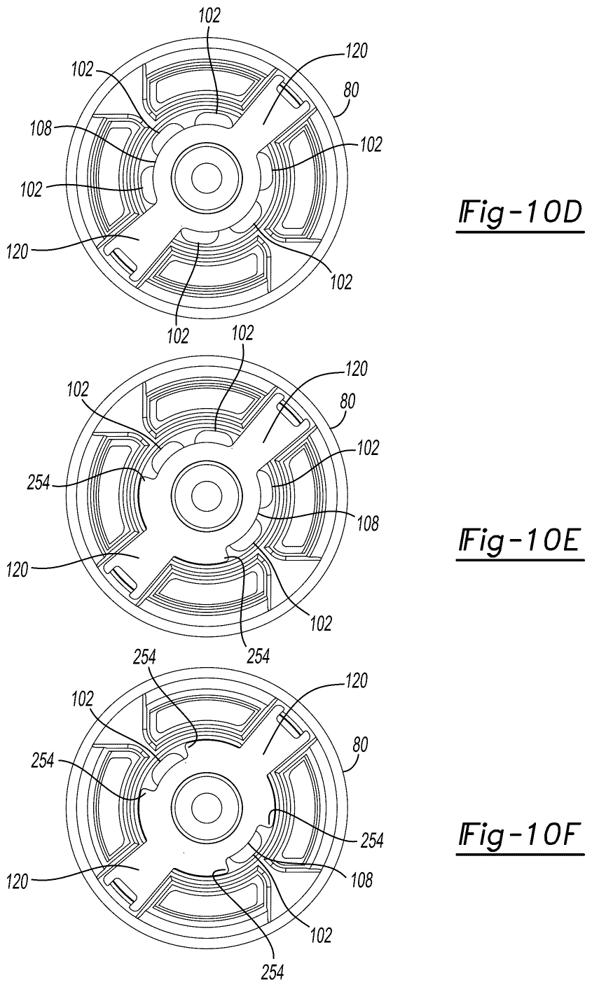

Referring now to FIGS. 10A-10F, embodiments of the orifice disc 108 are described. The orifice disc 108 shown in FIGS. 10B and 10C are direct replacement for the orifice disc 108 shown in FIGS. 4 and 10A.

In some embodiments, the orifice disc 108 further includes one or more restriction lobes 254 extending radially outward from the ring 116. As shown in FIGS. 10A-10F, in some embodiments, the restriction lobes 254 are connected to the fingers 120.

The restriction lobes 254 have a length defined as a radius 256 extending from the axis 52. In some embodiments, each restriction lobe 254 has the same radius 256. In some embodiments, the radius 256 of one or more restriction lobes 254 may differ from the radius 256 of one or more other restriction lobes 254. Not all restriction lobes 254 need to have the same radius 256. The restriction lobes 254 are configured to extend toward the inlets of one or more of the compression flow passages 102.

Where the radius 256 of the restriction lobes 254 is of a sufficient dimension, the restriction lobes 254 may at least partially cover one or more of the inlets to the compression flow passages 102. A larger radius 256 will cover more of the underlying inlets to the compression flow passages 102. Accordingly, a larger radius 256 will increase the restriction on the flow of hydraulic fluid into and through the compression flow passages 102.

As shown in FIGS. 10B and 10E, the orifice disc 108 includes two restriction lobes 254 proximate to one of the fingers 120, wherein the two restriction lobes 254 completely cover two of the compression flow passages 102 of the valve body 80. As shown in FIGS. 10C and 10F, the orifice disc 108 includes four restriction lobes 254, with two restriction lobes 254 proximate to one of the fingers 120 and two restriction lobes 254 proximate to the other of the fingers 120, wherein the four restriction lobes 254 completely cover four of the compression flow passages 102 of the valve body 80. As shown in FIGS. 10B, 10C, 10E, and 10F, the restriction lobes 254 may all have the same radius 256.

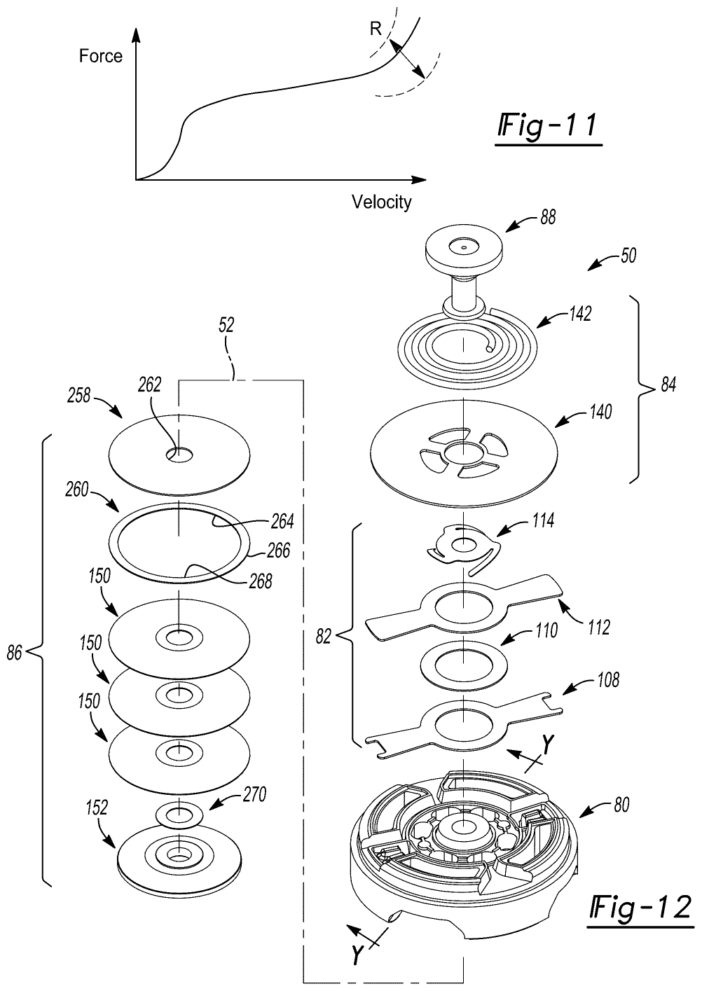

In some embodiments, in addition to or alternative to varying the number of restriction lobes 254, the radius of the restriction lobes 254 may be varied to tune the shock absorber 30. For example, depending on the radius 256 of the restriction lobes 254, one or more of the compression flow passages 102 can be covered from 0% to 100%. As the percent of coverage of the compression flow passages 102 increases, the restriction of fluid flow through the compression flow passages 102 increases. As shown in FIG. 11, increasing the coverage percentage provided by the restriction lobes 254 of the orifice disc 108 increases the damping force at higher velocities, as shown in factor R of the force response curve of the shock absorber 30.

In some embodiments, the shock absorber 30 is provided as a kit wherein the kit has a plurality of orifice discs 108. For example, the kit includes a plurality of orifice discs 108, wherein each orifice disc 108 includes a different number of restriction lobes 254 (e.g., zero restriction lobes 254, one restriction lobe 254, two restriction lobes 254, three restriction lobes 254, four restriction lobes 254) to provide a different amount of restriction of the compression flow passages 102.

In some embodiments, the kit includes a plurality of orifice discs 108, wherein each orifice disc 108 is configured to cover a different percentage of the compression flow passages 102, to provide a different percent of restriction. The radial length or radius 256 of the restriction lobes 254 therefore differs between each orifice disc 108 provided in the kit. For example, a first orifice disc 108 in the kit may have one or more restriction lobes 254 configured to cover 20% of the compression flow passages, a second orifice disc 108 in the kit may have one or more restriction lobes 254 configured to cover 40% of the compression flow passages, a third orifice disc 108 in the kit may have one or more restriction lobes 254 configured to cover 60% of the compression flow passages, a fourth orifice disc 108 in the kit may have one or more restriction lobes 254 configured to cover 80% of the compression flow passages, and a fifth orifice disc 108 in the kit may have one or more restriction lobes 254 configured to cover 100% of the compression flow passages.

In some embodiments, the kit includes a plurality of orifice discs 108, wherein a subset of the orifice discs 108 includes a different number of restriction lobes 254 and a subset of the orifice discs 108 includes restriction lobes 254 having different radii of restriction lobes 254. In some embodiments, the kit includes a plurality of orifice discs 108, wherein a subset of the orifice discs 108 includes a different number of restriction lobes 254, a subset of the orifice discs 108 includes restriction lobes 254 having different radii of restriction lobes 254, and a subset of the orifice discs 108 includes a different number of restriction lobes 254 having different radii. Accordingly, one of the orifice discs 108 of the kit may be selected and included in the shock absorber 30 based on a desired damping response.

### Alternative Embodiment—Preload Ring

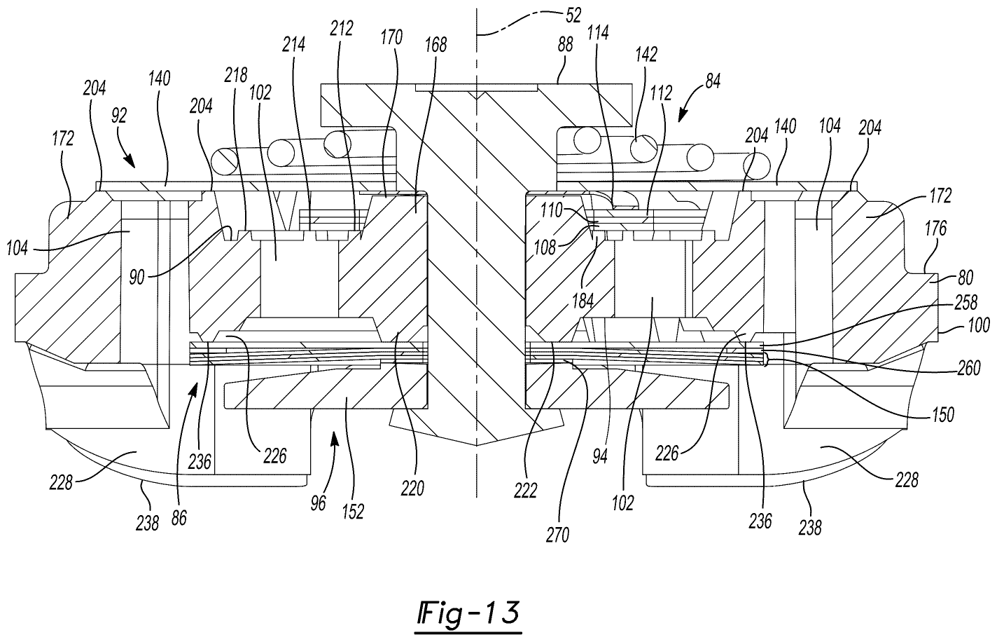

Now with reference to FIGS. 12 and 13, an alternative embodiment of the base valve assembly 50 is shown and described. In this embodiment, the compression valve assembly 86 includes a blowoff disc 258 and a preload ring 260. The blowoff disc 258 is a circular disc having a center hole 262.

The preload ring 260 is circular in shape, having a hole 264 extending through the preload ring 260. Although the hole 264 of the preload ring 260 is shown as circular, it will be understood that, in some embodiments, the hole 264 is elliptical. In some embodiments, the hole 264 is concentric with the outer surface 266 of the preload ring 260. In some embodiments, the hole 264 is eccentric with the outer surface 266 of the preload ring 260.

Although the hole 264 of the preload ring 260 is shown and described as having a circular or elliptical shape, it will be understood that the preload ring 260 may have an inner surface 268 of any shape that forms a hole 264 of any corresponding shape such that the cross-sectional width of the preload ring 260 varies along the circumference of the preload ring 260. For example, in some embodiments, the hole 264 may be any regular, irregular, or asymmetrical shape that is either concentric or eccentric with the outer surface 266 of the preload ring 260 such that the cross-sectional width of the preload ring 260 varies along the circumference of the preload ring 260. As an example only, in some embodiments, the hole 264 may have an irregular, wavy, asymmetrical shape that is eccentric with the outer surface 266 of the preload ring 260. Exemplary embodiments of the preload ring 260 are shown and described in co-pending application U.S. Ser. No. 18/397,415, the entirety of which is incorporated by reference herein. The preload ring 260 may be metal, plastic, or any suitable material. The preload ring 260 is configured to provide internal preload forces to the valve discs 150. Tuning of the opening of the blowoff disc 258 may be achieved by modifying the shape, size, and/or orientation of the hole 264 of the preload ring 260.

In some embodiments, the blowoff disc 258 and preload ring 260 are coupled together, for example only, by one or more spot welds. As shown in FIGS. 12 and 13, when assembled into the base valve assembly 50, the blowoff disc 258 and the preload ring 260 are located axially between the second side 96 of the valve body 80 and the valve discs 150. Specifically, as shown in FIG. 13, in some embodiments, for example, the second hub face 222 of the second hub 220 is located the same distance as the first distance of the first disc lands 234 and the second disc lands 236. That is, the second hub face 222 is coplanar with the first disc lands 234 and the second disc lands 236. In such embodiments, the preload disc 148 is not required. Additionally, in such embodiments, the blowoff disc 258 is in contact with the second hub face 222, the first disc lands 234, and the second disc lands 236. This can improve sealing between the blowoff disc 258 and the valve body 80.

Additionally, as shown in FIGS. 12 and 13, in some embodiments, the compression valve assembly 86 includes a second fulcrum disc 270 located axially between the backup washer 152 and the stack of valve discs 150. This optional second fulcrum disc 270 may be used to tune the travel of the stack of valve discs 150. The optional second fulcrum disc 270 may be omitted and tuning of the travel of the stack of valve discs 150 may be accomplished via modifying the backup washer 152.

### Tuning of Base Valve Assembly

Tuning of the shock absorber 30 may be accomplished by varying one, some, or all of the parameters of the base valve assembly 50. For example only and without limitation, one, some, or all of the following may be varied, selected, or designed to tune the shock absorber 30: (1) the spring force of the arm spring 114; (2) the thickness of the intake disc 140, the shape of the openings 146 of the intake disc 140, and/or the open area of the openings 146 of the intake disc 140; (3) the spring force of the intake spring 142; (4) the thickness of the check disc 112 and/or the diameter of the ring 128 of the check disc 112; (5) the thickness of the fulcrum disc 110 and/or the diameter of the ring 124 of the fulcrum disc 110; (6) the width and/or depth of the orifices 122 of the orifice disc 108, the number of restriction lobes 254 of the orifice disc 108, and/or the size of the restriction lobes 254 of the orifice disc 108; (7) the number, size, and/or shape of the bleed flow passages 106, compression flow passages 102, and/or rebound flow passages 104; (8) the thickness of the preload disc 148; (9) the number, thickness, and/or diameter of the valve discs 150; (10) the angle of the angled surface 166 of the backup washer 152; (11) the thickness of the blowoff disc 258; and/or (12) the thickness of the preload ring 260 and/or the shape, size, and/or location of the hole 264 of the preload ring 260.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A shock absorber for a vehicle comprising:
a pressure tube;
a reserve tube surrounding the pressure tube to define a fluid reservoir chamber between the pressure tube and the reserve tube;
a piston assembly slidably fitted in the pressure tube and separating the pressure tube into a first working chamber and a second working chamber; and
a base valve assembly, the base valve assembly configured to control the flow of fluid between the second working chamber and the fluid reservoir chamber, the base valve assembly comprising:
a valve body, the valve body comprising:
a first surface on a first side of the valve body;
a second surface on a second side of the valve body;
a rebound flow passage extending through the valve body;
a first circumferential land on the first side surrounding the rebound flow passage, the first circumferential land being located a first distance away from the first surface and a greater distance away from the second surface;
a bleed flow passage extending through the valve body;
a second circumferential land on the first side surrounding the bleed flow passage, the second circumferential land being located a second distance away from the first surface, the second distance being less than the first distance, and the second circumferential land being between the first surface and the first circumferential land; and
a compression flow passage extending through the valve body.

2. The shock absorber of claim 1, wherein the base valve assembly further comprises:
a rebound valve assembly having a first disc; and
a bleed valve assembly having a second disc.

3. The shock absorber of claim 2, wherein:
the first disc is selectively driven into engagement with the first circumferential land; and
the second disc includes a first portion selectively driven into engagement with the second circumferential land and a second portion spaced apart from the valve body.

4. The shock absorber of claim 3, wherein the valve body further comprises one or more notches extending from one or more of the first circumferential land toward the first surface and the second circumferential land toward the first surface.

5. The shock absorber of claim 1, wherein the base valve assembly further comprises a bleed valve assembly comprising an orifice disc including:
a ring having a center hole; and
a first finger extending radially outward from the ring, the first finger configured to cover the bleed flow passage, and the first finger having a first bleed orifice, wherein the first bleed orifice remains open regardless of position of the orifice disc.

6. The shock absorber of claim 5, wherein the orifice disc further comprises one or more restriction lobes configured to at least partially cover the compression flow passage.

7. The shock absorber of claim 1, wherein the valve body further comprises a bleed flow guide cavity fluidly connected to the bleed flow passage, the bleed flow guide cavity extending into the valve body from the first surface of the valve body.

8. The shock absorber of claim 7, wherein the bleed flow guide cavity includes a wall that slopes toward the bleed flow passage.

9. The shock absorber of claim 7, further comprising a bleed inlet support located in the bleed flow guide cavity, the bleed inlet support terminating with a bleed land, the bleed land is coplanar with the second circumferential land.

10. The shock absorber of claim 1, wherein the valve body includes a first disc support on the second side of the valve body and partially surrounding the bleed flow passage, the first disc support extending a third distance away from the second surface and terminating in a first disc land.

11. The shock absorber of claim 10, wherein the first disc support forms a bleed port through which fluid may flow, and wherein the bleed port is configured to be open to the flow of fluid when a valve disc is in contact with the first disc land.

12. The shock absorber of claim 1, further comprising a population of lands on the first surface of the valve body, the population of lands configured to support a surface of a valve disc and permits flow of fluid beneath the surface of the valve disc.

13. The shock absorber of claim 1, wherein the valve body further comprises a third circumferential land on the second side of the valve body surrounding the compression flow passage, wherein the third circumferential land is located a third distance away from the second surface.

14. The shock absorber of claim 13, wherein the base valve assembly further comprises a compression valve assembly having a blowoff disc, wherein the blowoff disc is selectively driven into engagement with the third circumferential land.

15. The shock absorber of claim 14, the compression valve assembly further comprising a preload ring, the blowoff disc located axially between the second side of the valve body and the preload ring.

16. A shock absorber for a vehicle, the shock absorber comprising:
a pressure tube;
a reserve tube surrounding the pressure tube to define a fluid reservoir chamber between the pressure tube and the reserve tube;
a piston body slidably fitted in the pressure tube and separating the pressure tube into a first working chamber and a second working chamber; and
a base valve assembly, the base valve assembly configured to control the flow of fluid between the second working chamber and the fluid reservoir chamber, the base valve assembly comprising:
a valve body, the valve body comprising:
a first surface on a first side of the valve body;
a second surface on a second side of the valve body;
a bleed flow passage extending through the valve body; and
a bleed flow guide cavity fluidly connected to the bleed flow passage, the bleed flow guide cavity extending into the valve body from the first surface of the valve body; and
a bleed valve assembly having a first disc, at least a portion of the first disc configured to selectively cover at least a portion of the bleed flow passage and the bleed flow guide cavity.

17. The shock absorber of claim 16, wherein the bleed flow guide cavity extends into the valve body from the first surface toward the second surface and includes a wall that is located between first surface and the second surface.

18. The shock absorber of claim 16, wherein the first disc of the bleed valve assembly comprises an orifice disc including:
a ring having a center hole; and
a first finger extending radially outward from the ring, the first finger configured to cover the bleed flow passage and at least a portion of the bleed flow guide cavity, the first finger having a first bleed orifice, wherein the first bleed orifice remains open regardless of position of the orifice disc.

19. The shock absorber of claim 18, wherein the valve body further comprises a compression flow passage extending through the valve body and wherein the orifice disc further comprises one or more restriction lobes configured to at least partially cover the compression flow passage.

20. A shock absorber for a vehicle, the shock absorber comprising:
a pressure tube;
a reserve tube surrounding the pressure tube to define a fluid reservoir chamber between the pressure tube and the reserve tube;
a piston body slidably fitted in the pressure tube and separating the pressure tube into a first working chamber and a second working chamber; and
a base valve assembly, the base valve assembly configured to control the flow of fluid between the second working chamber and the fluid reservoir chamber, the base valve assembly comprising:
a valve body, the valve body comprising:
a first surface on a first side of the valve body;
a second surface on a second side of the valve body;
a bleed flow passage extending through the valve body; and
a compression flow passage extending through the valve body; and
a bleed valve assembly on the first side of the valve body, the bleed valve assembly having an orifice disc, the orifice disc including:
a ring having a center hole;
a first finger extending radially outward from the ring, the first finger configured to cover the bleed flow passage, and the first finger having a first bleed orifice, wherein the first bleed orifice remains open regardless of position of the orifice disc; and
a restriction lobe, the restriction lobe configured to cover the compression flow passage.
